(19) United States
(12) Patent Application Publication
(10) Pub. No.: US 2006/0243604 A1
(43) Pub. Date: Nov. 2, 2006

(54) Method and apparatus for treating waste water

(76) Inventors: Sota Nakagawa, Tokyo (JP); Masaji Akahori, Tokyo (JP); Makoto Kashiwagi, Tokyo (JP); Keiji Maishigi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/554,462

(22) PCT Filed: Apr. 28, 2004
(86) PCT No.: PCT/JP04/06167

§ 371 Date: Oct. 25, 2005

(30) Foreign Application Priority Data
Apr. 30, 2003 (JP) 2003-125889
Jun. 10, 2003 (JP) 2003-165798

(51) Int. Cl. G01N 27/26

(52) U.S. Cl. 205/775; 423/23; 210/758; 204/554; 210/759

(57) ABSTRACT

The present invention relates to a method and apparatus for removing and recovering metal such as copper from various kinds of waste water containing copper. A method for treating waste water includes treating waste water in a copper treatment step (10) comprising a combination of electrodialysis operation and electrolytic deposition operation to produce treated water (107) having a lowered copper concentration, and recovering copper from the waste water.

### TECHNICAL FIELD

The present invention relates to a method and apparatus for removing and recovering metal such as copper from various kinds of waste water to be treated.

### BACKGROUND ART

In a case of treating waste water containing heavy metal, such as waste water produced in plating, waste water produced in semiconductor device fabrication processes, waste water produced in fabrication of printed circuit boards, or waste water produced in mines, it has been required to remove heavy metal from waste water and recover the heavy metal as needed.

For example, in fabrication processes for semiconductor devices such as semiconductor integrated circuits, demands for semiconductor devices having finer interconnections or elements have further increased in recent years to thereby cause a problem of signal delay due to interconnection resistance. In order to solve this problem, aluminum or tungsten is replaced with copper for interconnections.

Specifically, as semiconductor chips such as central processing units (CPU) or dynamic random access memories (DRAM) have become more highly integrated, materials for interconnections in semiconductor chips, particularly for interconnections having a minimum width of 0.13 μm or smaller, have changed from aluminum into copper which has an electrical resistance lower than aluminum.

It is difficult to etch a copper layer in a semiconductor chip to form a pattern in the semiconductor chip. Therefore, when copper is used for interconnections in semiconductor chips, a semiconductor substrate is plated with copper by damascene process to deposit a copper layer on the semiconductor substrate, and then a surface of the copper layer is polished by chemical mechanical polishing (CMP) or electrochemical polishing (ECP) to form interconnections on the semiconductor substrate.

FIGS. 25A thorough 25E show an example of a process for forming an interconnection on a semiconductor substrate. As shown in FIG. 25A, a conductive layer 202 is formed on a semiconductor substrate 201 on which semiconductor devices have been formed, and an insulating film 203 of SiO₂ is deposited on the conductive layer 202. A contact hole 204 and an interconnection groove 205 are formed in the insulating film 203 by lithography etching technology. Then, as shown in FIG. 25B, a barrier layer 206 is formed on the insulating film 203. The barrier layer 206 is made of metal such as Ta, TaN, TiN, WN, SiTiN, COWP, or COWB, or metallic compound thereof. In a case of forming a copper layer by electrolytic plating, as shown in FIG. 25C, a copper seed layer 207, which is used as a feeding layer in electrolytic plating, is further formed on the barrier layer 206 by sputtering or the like. In a case of forming a copper layer by electroless plating, a catalyst layer 207 is formed on the barrier layer 206 by pretreatment instead of the copper seed layer.

Subsequently, as shown in FIG. 25D, electrolytic copper plating or electroless copper plating is applied onto a surface of the copper seed layer 207 or the catalyst layer 207 to fill the contact hole 204 and the interconnection groove 205 with copper and to deposit a copper layer 208 on the insulating film 203. Thereafter, the copper layer 208 on the insulating film 203 is removed by chemical mechanical polishing (CMP) or electrochemical polishing (ECP) so that a surface of the copper layer 208 filled in the contact hole 204 and the interconnection groove 205 is substantially flushed with a surface of the insulating film 203. Thus, as shown in FIG. 25E, an interconnection comprising the copper seed layer or the catalyst layer 207, and the copper layer 208 is formed in the insulating film 203.

Waste water containing a large number of copper ions is produced in an electrolytic copper plating process and an electroless copper plating process in a semiconductor device fabrication process, and a chemical mechanical polishing (CMP) process and an electrochemical polishing (ECP) process for microchips having integrated circuits. With respect to an allowable limit of copper ions contained in waste water, a maximum concentration of copper ions is restricted to 3.0 mg/l or lower in Japan. In the United States, a concentration of copper ions is more strictly limited than in Japan. For example, a maximum concentration of copper ions is restricted to 2.7 mg/l or lower, an average concentration of copper ions per day is restricted to 1.0 mg/l or lower, and an average concentration of copper ions per year is restricted to 0.4 mg/l or lower. Therefore, there has been strongly required to provide technology capable of efficiently removing copper from waste water.

In a general type of semiconductor device fabrication plant, a single CMP apparatus produces waste water having a maximum flow rate of about 0.5 m³/h and having a maximum copper concentration of about 100 mg/l. A single copper plating apparatus produces waste water having a maximum flow rate of about 0.2 m³/h and having a maximum copper concentration of about 100 mg/l. In average fabrication plants for semiconductor devices having copper interconnections, there may be provided about ten CMP apparatuses and about ten to twenty copper plating apparatuses per a plant. In such a case, the total flow rate of waste water containing copper becomes as high as about 220 m³/day at the maximum, and the total amount of copper contained in the waste water becomes as much as about 22 kg-Cu/day at the maximum. Thus, there has been strongly required to efficiently recover and reuse copper from waste water in view of resource saving as well as environmental protection.

In a conventional installation industry including a semiconductor device fabrication industry, waste water has been treated by a comprehensive waste water treating system in which waste water has been collected from various processes in a plant and has been collectively treated. However, in a semiconductor device fabrication industry in which fabrication processes have been rapidly improved, there has been required to treat waste water discharged from respective processes on the point of use, i.e., at locations where water has been used. This reason is as follows: Production systems have changed from conventional mass production into diversified flexible production. Types of products are changed so frequently that variation of properties of waste water becomes numerous.

Because a concentration of copper in waste water produced chemical mechanical polishing (CMP) process or waste water produced in copper plating is normally 100 mg/l or lower, heretofore there has not been used an electrolytic deposition process due to the problem of operating voltage rise. Further, copper is adsorbed and recovered by ion exchange resin as copper ions in an ion exchange resin process, and copper is precipitated and recovered in the form of hydroxide or oxide in a coagulating sedimentation process, and hence further treatment is required to recycle the recovered copper in both processes.

### DISCLOSURE OF INVENTION

Under these circumstances, there has been required a method and apparatus for removing and recovering metal such as copper from waste water which can treat waste water containing copper ions in a wide range from a high concentration to a low concentration, and can sufficiently treat a large amount of waste water. Particularly, there has been required a method and apparatus for removing and recovering copper from waste water produced in semiconductor device fabrication processes.

The present inventors have found from an extensive study that as a method for treating waste water containing copper discharged from a semiconductor device fabrication process, copper in waste water can be efficiently removed and recovered by combining electrolytic deposition operation and electrodialysis operation. Specifically, according to one aspect of the present invention, there is provided a treatment method for treating water containing copper by combining electrolytic deposition operation and electrodialysis operation.

In order to achieve the above subject, according to a first aspect of the present invention, there is provided a method for treating waste water containing copper, comprising: treating waste water in a copper treatment step comprising a combination of electrodialysis operation and electrolytic deposition operation to produce treated water having a lowered copper concentration; and recovering copper from the waste water.

According to a second aspect of the present invention, there is provided a method for treating waste water containing copper, comprising: decomposing oxidizing agent in waste water in an oxidizing agent decomposition step; supplying the waste water discharged from the oxidizing agent decomposition step to a copper treatment step; treating the waste water in the copper treatment step comprising a combination of electrodialysis operation and electrolytic deposition operation to produce treated water having a lowered copper concentration; and recovering copper from the waste water.

As treatment processes usable for removing an oxidizing agent, such as hydrogen peroxide, contained in the above-described water to be treated, there may be catalytic decomposition with activated carbon, catalytic decomposition with a noble metal catalyst, e.g. a titania-supported platinum catalyst or an alumina-supported platinum catalyst, catalytic decomposition with a manganese dioxide catalyst, electrolysis, ultraviolet-rays treatment, ozone addition, decomposition treatment with a reducing agent such as hydrazine, sodium thiosulfate or sodium sulfite, and enzymatic hydrolysis with an H₂O₂ degrading enzyme (catalase), etc. When using a platinum catalyst such as an alumina-supported platinum catalyst, it is preferred to use a honeycomb-shaped catalyst because of its large specific surface area, its good gas-separability and increased decomposition rate.

Further, a honeycomb-shaped catalyst can be provided with successive openings in the flow direction, so that particles smaller than the opening area may be passed through the openings without being accumulated in the catalyst. The honeycomb-shaped catalyst can therefore be advantageously used for decomposing an oxidizing agent contained in slurry-containing waste water such as CMP waste water.

According to a preferred aspect of the present invention, the oxidizing agent decomposition step may use a platinum-coated catalyst.

According to a preferred aspect of the present invention, the oxidizing agent decomposition step may comprise a hydrogen peroxide decomposition step.

According to a preferred aspect of the present invention, the copper recovered from the waste water may comprise copper metal.

According to a preferred aspect of the present invention, a method for treating waste water may further comprise a slurry separation step for separating slurry from the waste water, the slurry separation step being provided between the oxidizing agent decomposition step and the copper treatment step.

According to a preferred aspect of the present invention, the slurry separation step may include coagulating separation treatment or filtering treatment.

According to a preferred aspect of the present invention, the copper treatment step may comprise a separation step for separating and concentrating copper in the waste water by electrodialysis operation as CuSO₄ concentrated water, a recovering step for depositing copper on a cathode of an electrolytic deposition apparatus by electrolytic deposition operation of the CuSO₄ concentrated water, and an acid recovery step for recovering sulfuric acid from treated water of the recovery step.

According to a preferred aspect of the present invention, a method for treating waste water may further comprise a ζ potential converting step provided at a preceding stage of the copper treatment step; wherein the waste water containing solid fine particles may be treated by the ζ potential converting step.

According to a preferred aspect of the present invention, the waste water containing solid fine particles may be directly introduced into the copper treatment step when a ζ potential of the fine particles is a negative value.

According to a preferred aspect of the present invention, in the ζ potential converting step, organic compound having sulfo group may be added to the waste water.

According to a preferred aspect of the present invention, the solid fine particles may comprise abrasive particles used in a CMP step.

According to a preferred aspect of the present invention, the abrasive particles may contain at least one of SiO₂, Al₂O₃ and CeO₂.

According to a preferred aspect of the present invention, in the ζ potential converting step, a surfactant or a pH adjusting agent may be added to the waste water.

According to a third aspect of the present invention, there is provided a method for treating waste water containing copper, comprising: treating waste water in a copper treatment step comprising a combination of electrodialysis operation and electrolytic deposition operation to produce treated water having a lowered copper concentration, the waste water comprising waste water discharged from a CMP step for polishing a semiconductor substrate having a copper layer thereon and/or a cleaning step for cleaning the polished semiconductor substrate using a cleaning liquid; and recovering copper from the waste water.

According to a preferred aspect of the present invention, a method for treating waste water may further comprise a potential converting step provided at a preceding stage of the copper treatment step.

According to a preferred aspect of the present invention, the surfactant may comprise an anionic surfactant or a nonionic surfactant.

According to a preferred aspect of the present invention, the anionic surfactant may contain no metal cation.

According to a preferred aspect of the present invention, the solid fine particles may comprise abrasive particles, and the abrasive particles contain at least one of SiO₂, Al₂O₃ and CeO₂.

According to a preferred aspect of the present invention, the cleaning liquid in the cleaning step may contain a surfactant.

According to a fourth aspect of the present invention, there is provided a method for treating waste water containing copper, comprising: introducing waste water into a ζ potential converting step to convert a ζ potential of solid fine particles in the waste water into a negative value, the waste water comprising waste water discharged from a CMP step for polishing a semiconductor substrate having a copper layer thereon and/or a cleaning step for cleaning the polished semiconductor substrate using a cleaning liquid; and treating the waste water containing the fine particles in an ion-exchange treatment step to produce treated water having a lowered copper concentration.

According to a preferred aspect of the present invention, a method for treating waste water may further comprise an oxidizing agent decomposition step provided at a preceding stage of the ion-exchange treatment step.

According to a fifth aspect of the present invention, there is provided a method for treating waste water containing copper, comprising: introducing waste water into a ζ potential converting step to convert a λ potential of solid fine particles in the waste water into a negative value, the waste water comprising waste water discharged from a CMP step for polishing a semiconductor substrate having a copper layer thereon and/or a cleaning step for cleaning the polished semiconductor substrate using a cleaning liquid; and treating the waste water containing the fine particles in a coagulating sedimentation treatment step or a coagulating separation treatment step to produce treated water having a lowered copper concentration.

According to a preferred aspect of the present invention, a method for treating waste water may further comprise an oxidizing agent decomposition step provided at a preceding stage of the coagulating sedimentation treatment step or the coagulating separation treatment step.

According to a sixth aspect of the present invention, there is provided a method for treating waste water, comprising: treating waste water discharged only from a copper polishing step in a CMP step to produce treated water having a lowered copper concentration.

According to a preferred aspect of the present invention, the treating waste water may comprise at least one of electrodialysis treatment, electrolytic deposition treatment, ion-exchange treatment, and coagulating sedimentation treatment.

According to a seventh aspect of the present invention, there is provided an apparatus for treating waste water containing copper, comprising: an electrodialysis apparatus; and an electrolytic deposition apparatus; wherein waste water is treated by a combination of the electrodialysis apparatus and the electrolytic deposition apparatus to produce treated water having a lowered copper concentration and to recover copper.

According to a preferred aspect of the present invention, the copper recovered from the waste water may comprise copper metal.

According to a preferred aspect of the present invention, the electrodialysis apparatus may perform electrodialysis operation of the waste water to separate and concentrate copper in the waste water as CuSO₄ concentrated water; the electrolytic deposition apparatus may perform electrolytic deposition operation of the CuSO₄ concentrated water to deposit copper on a cathode of the electrolytic deposition apparatus; the apparatus for treating waste water may further comprise an acid recovery apparatus for recovering sulfuric acid from treated water discharged from the electrolytic deposition apparatus.

According to a preferred aspect of the present invention, the electrodialysis apparatus may have a desalting chamber packed with an ion-exchanger.

According to a preferred aspect of the present invention, an apparatus for treating waste water may further comprise a ζ potential converting apparatus provided at a preceding stage of the electrodialysis apparatus.

According to a preferred aspect of the present invention, the ζ potential converting apparatus may comprise a chemical storage tank configured to store a surfactant or a pH adjusting agent, and an adding device configured to add the surfactant or the pH adjusting agent stored in the chemical storage tank to the waste water.

According to a preferred aspect of the present invention, the surfactant may comprise an anionic surfactant or a nonionic surfactant.

### BRIEF DESCRIPTION OF DRAWINGS

FIG. 1 is a schematic view showing a treatment flow of a treatment method for treating waste water by combining electrolytic deposition operation and electrodialysis operation according to the present invention;

FIG. 2 is a schematic view showing an overall treatment flow in which the treatment flow of FIG. 1 is shown in detail;

FIG. 3 is a schematic view showing a hydrogen peroxide decomposition step in detail;

FIG. 4 is a schematic view showing a slurry separation step in detail;

FIG. 5 is a schematic view showing an example of a copper treatment step;

FIG. 6 is a schematic view showing another example of a copper treatment step;

FIG. 7 is a schematic view showing an electrolytic deposition apparatus according to a first embodiment of the present invention;

FIGS. 8A and 8B are schematic views showing electrolytic deposition apparatuses according to a second embodiment of the present invention;

FIG. 9 is a schematic view showing a method for treating hydrogen gas generated in electrolytic deposition apparatuses and electrodialysis apparatuses according to the present invention;

FIG. 10 is a schematic view showing another method for treating hydrogen gas generated in electrolytic deposition apparatuses and electrodialysis apparatuses according to the present invention;

FIG. 11 is a schematic view showing a method for treating hydrogen gas generated in electrolytic deposition apparatuses and electrodialysis apparatuses according to the present invention;

FIGS. 12A and 12B are conceptual views showing a method of detecting an abnormal state by monitoring water in quality or in quantity which is obtained by a waste water treatment apparatus according to the present invention;

FIG. 13 is a schematic view showing a waste water treatment system for treating waste water produced in a semiconductor device fabrication process;

FIG. 14 is a schematic view showing a relationship between a CMP apparatus and a waste water treatment system according to the present invention;

FIG. 15 is a schematic view showing a case of introducing waste water discharged from an apparatus that carries out etching and cleaning steps, or plating, etching and cleaning steps in the same chamber into a waste water treatment system;

FIG. 16 is a schematic view showing a case of collectively treating waste water discharged from a plurality of apparatuses that perform an identical step;

FIG. 17 is a perspective view showing a waste water treatment unit provided within a casing;

FIGS. 18A and 18B are views showing preferable positional relationships between a CMP apparatus, a plating apparatus or an ECP apparatus and a waste water treatment system according to the present invention;

FIGS. 19A through 19C are views showing cases of collectively treating waste water discharged from apparatuses that perform different process steps;

FIG. 20 is a schematic view showing a waste water treating system according to an embodiment of another aspect of the present invention;

FIGS. 21A and 21B are schematic views showing a method of installing, in a semiconductor device fabrication plant, a waste water treatment apparatus according to an embodiment of the present invention;

FIG. 22 is a schematic view showing a copper treatment apparatus according to an embodiment of another aspect of the present invention;

FIGS. 23A and 23B are schematic views showing treatment flows in a case where a ζ potential converting step is provided upstream of a copper treatment step;

FIGS. 24A and 24B are schematic views showing a ζ potential converting apparatus for carrying out the ζ potential converting step;

FIGS. 25A through 25E are schematic views showing an example of a process for forming a copper interconnection in a semiconductor chip;

FIG. 26 is a schematic view showing an electrodialysis apparatus for performing two steps between a set of an anode and a cathode;

FIG. 27 is a schematic view showing an example of a membrane combined-type electrolytic deposition apparatus; and

FIGS. 28A and 28B are schematic views showing examples of Cu-CMP apparatuses.

### BEST MODE FOR CARRYING OUT THE INVENTION

An apparatus for treating water to be treated according to embodiments of the present invention will be described below with reference to the accompanying drawings. Like or corresponding parts are denoted by like or corresponding reference numerals throughout drawings, and will not be described below repetitively.

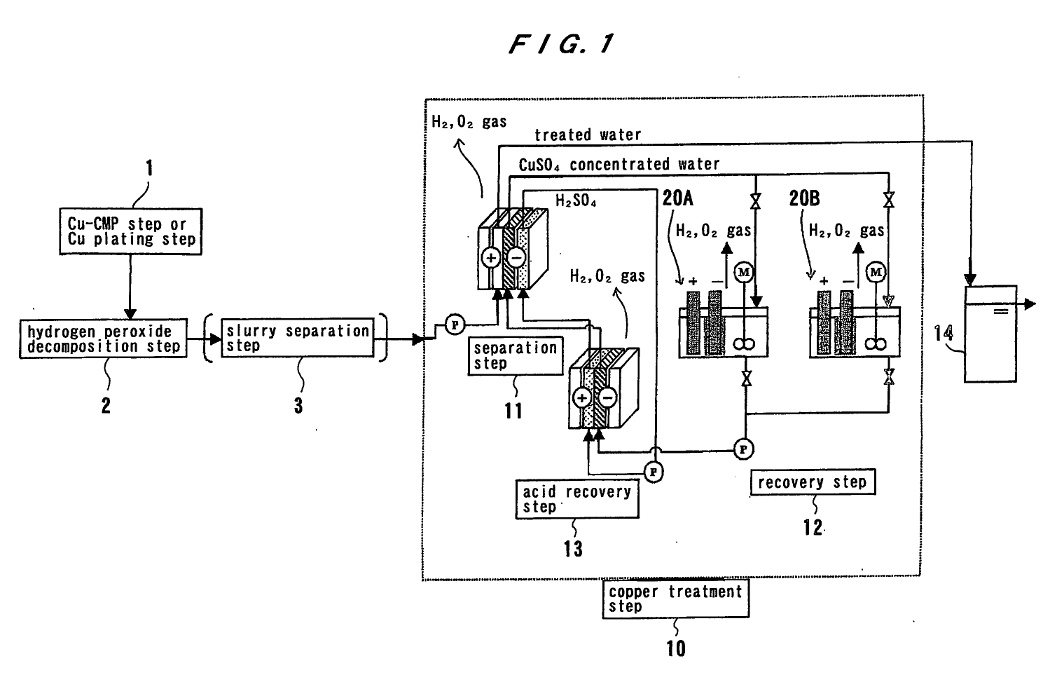

FIG. 1 is a schematic view showing a treatment flow of a treatment method for treating waste water by combining electrolytic deposition operation and electrodialysis operation according to the present invention.

Waste water (water to be treated) containing copper and discharged from a Cu-CMP step or a Cu plating step 1 in a semiconductor device fabrication process is supplied to a hydrogen peroxide decomposition step 2. In the hydrogen peroxide decomposition step 2, hydrogen peroxide contained in the waste water is decomposed by a platinum-coated catalyst. The waste water discharge from the hydrogen peroxide decomposition step 2 is supplied to a slurry separation step 3. In the Cu-CMP step, a slurry containing abrasive particles which comprise silica or alumina is used, and hence the slurry is aggregated and separated in the slurry separation step 3. Next, a supernatant liquid of the slurry separation step 3 is supplied to a copper treatment step (Cu treatment step) 10 to recover Cu (copper) in the form of copper metal.

The copper treatment step 10 comprises three steps of a separation step 11, a recovery step 12 and an acid recovery step 13. The waste water discharged from the slurry separation step 3 is subjected to electrodialysis operation in an electrodialysis apparatus provided in the separation step 11, thereby separating and concentrating Cu in the waste water as CuSO₄ concentrated water. The CuSO₄ concentrated water is supplied to the recovery step 12, and is subjected to electrolytic deposition in an electrolytic deposition apparatus provided in the recovery step 12, thereby depositing Cu on the cathode. Treated water of the recovery step 12 is supplied to the acid recovery step 13, and sulfuric acid is recovered by an acid recovery apparatus provided in the acid recovery step 13. Here, the recovery of sulfuric acid (H₂SO₄) means that SO₄²⁻ which has moved from a H₂SO₄ circulation line to a CuSO₄ concentrated water circulation line in the separation step 11 is returned to the H₂SO₄ circulation line by the electrodialysis operation. This recovery allows a concentration of sulfuric acid in the H₂SO₄ circulation line to be maintained.

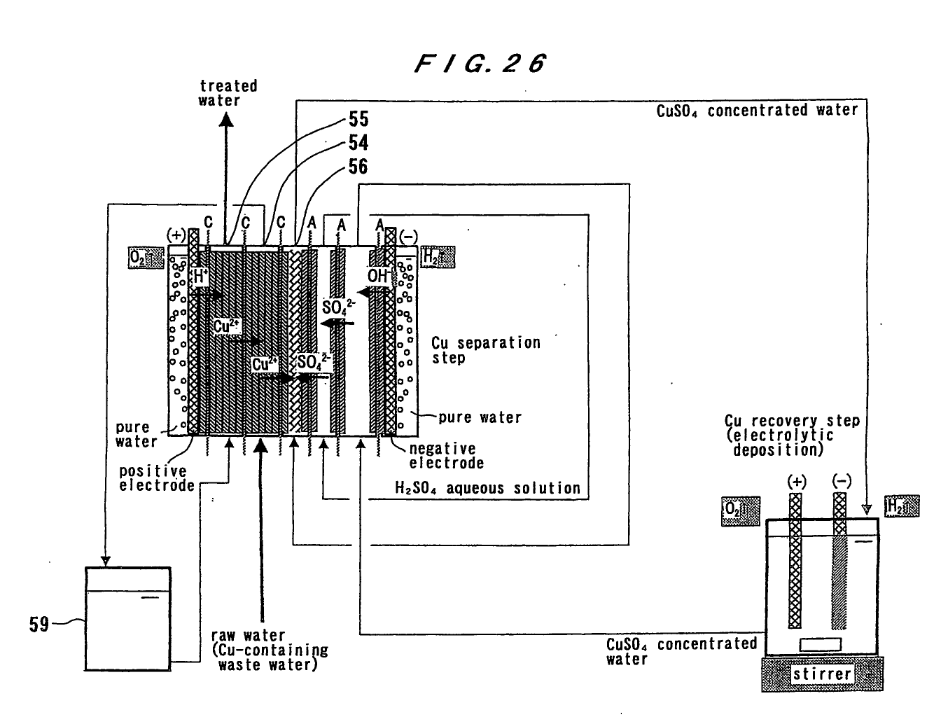

The separation step and the acid recovery step may be provided adjacent to each other or may be integrated with each other. In this case, as shown in FIG. 26, an electrodialysis apparatus for performing both steps between a set of an anode and a cathode may be constructed.

As shown in FIG. 1, two electrolytic deposition apparatuses are arranged in parallel in the recovery step 12. One of the electrolytic deposition apparatuses is shown by reference numeral 20A and the other is shown by reference numeral 20B. If CuSO₄ concentrated water is circulated in the electrolytic deposition apparatus 20A, the electrolytic deposition apparatus 20B is separated from the circulation system. While the electrolytic deposition apparatus 20A performs electrolytic deposition operation on Cu in the CuSO₄ concentrated water, the electrolytic deposition apparatus 20B serves to lower a Cu concentration in the remaining CuSO₄ concentrated water in the tank. After the Cu concentration in the tank is lowered sufficiently, water in the tank is discharged. After water is discharged from the tank, the tank is filled with acid solution using pure water and sulfuric acid newly. Thereafter, the CuSO₄ concentrated water circulation line is switched from the electrolytic deposition apparatus 20A to the electrolytic deposition apparatus 20B, and the CuSO₄ concentrated water is circulated through the electrolytic deposition apparatus 20B. At this time, the electrolytic deposition apparatus 20A is separated from the circulation system and the electrolytic deposition apparatus 20B performs deposition of Cu on the liquid remaining in the tank. By alternate operation of the electrolytic deposition apparatus 20A and the electrolytic deposition apparatus 20B repeatedly, even if cations other than copper ions are present in the waste water, cations concentrated together with Cu can be discharged periodically to the outside of the system. Further, steady operation is possible. In a case where liquid in the electrolytic deposition bath is discharged to the outside of the system, the discharge place may be the same as the discharge place of the treated water, or may be different from the discharge place of the treated water. If there is a limit to an installation space of the apparatus or the concentration of cations other than copper is extremely low, two electrolytic deposition apparatuses are not be necessarily required in parallel, and a single electrolytic deposition apparatus may be sufficient.

In FIG. 1, a treated water tank 14 serves to store treated water which has been treated to remove Cu in the separation step 11. Needless to say, the pH adjustment can be made in accordance with circumstances of the discharge place of the treated water. In FIG. 1, the slurry separation step 3 is put in parentheses, and this means that water discharged from the hydrogen peroxide decomposition step 2 may be directly supplied to the copper treatment step 10 without providing the slurry separation step 3.

If the slurry separation step is provided, then part of Cu in the waste water is discharged together with sludge generated by separation of slurry as mother liquid attached or adhered to the sludge, and hence such discharged Cu does not become an object to be treated in the copper treatment step.

In a case where water containing slurry is supplied to the copper treatment step 10 as it is, all of Cu contained in the waste water can be supplied to the copper treatment step. Thus, the recovery rate of Cu can be substantially increased.

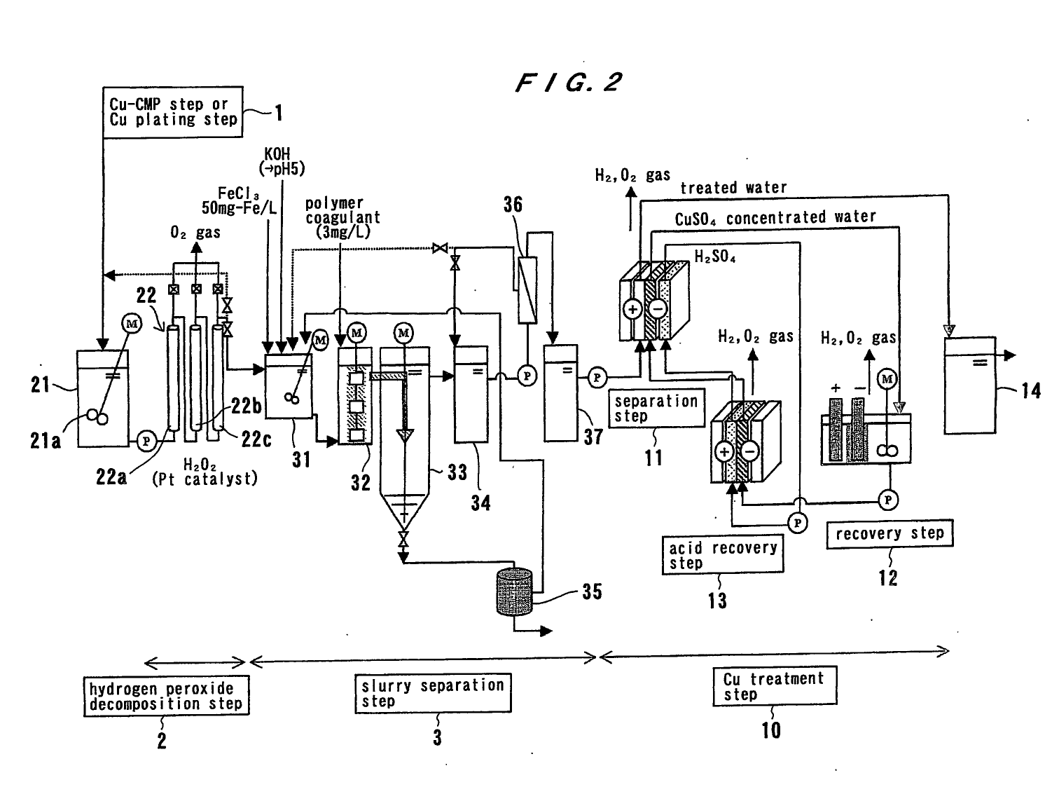

FIG. 2 is a schematic view showing an overall treatment flow in which the treatment flow of FIG. 1 is shown in detail. In FIG. 2, a single electrolytic deposition apparatus is shown. In the hydrogen peroxide decomposition step 2, waste water discharged from the Cu-CMP step or the Cu plating step 1 is supplied to an adjustment tank 21, and is stirred by a stirrer 21a in the adjustment tank 21. Decomposition of hydrogen peroxide is performed by using a platinum-coated catalyst comprising a metal honeycomb substrate and platinum coated by a surface of the metal honeycomb substrate in a hydrogen peroxide decomposition tower 22. Three columns 22a, 22b and 22c packed with the platinum-coated catalyst are provided in the hydrogen peroxide decomposition tower 22, and waste water is passed through the three columns 22a, 22n and 22c in series, thereby decomposing hydrogen peroxide into oxygen gas and water.

In the slurry separation step 3, there are provided a mixing tank 31, a coagulating tank 32, a solid-liquid separation tank 33, a circulation tank 34, a centrifugal separator 35, and a ceramic membrane 36. Ferric chloride serving as inorganic coagulant and potassium hydroxide serving as alkali are added to form coagulated flocs in the mixing tank 31. Other known inorganic coagulant and alkali may be used. A polymer coagulant is added in the coagulating tank 32. The polymer coagulant preferably comprises anionic polymer coagulant. Additive rate of the polymer coagulant is in the range of 1 to 5 mg/l, preferably 3 mg/l. If ferric chloride is used as inorganic coagulant, additive rate is in the range of 5 to 200 mg/l, preferably 50 mg/l. Potassium hydroxide is added as alkaline agent so that a pH of waste water becomes 5. By adding polymer coagulant, coagulated flocs are enlarged to increase sedimentation velocity of the coagulated flocs. The obtained sedimentation velocity is different from each other depending on additive rate of polymer coagulant, and is, however, approximately 100 mm/minute depending on the properties of slurry.

In the solid-liquid separation tank 33, solid matter (concentrate of coagulated floc) and liquid are separated from each other. The sludge settled and separated in the solid-liquid separation tank 33 is supplied to the centrifugal separator 35, and dehydrated sludge whose water content is about 85% can be obtained.

Mother liquid containing Cu and recovered in the centrifugal separator 35 is circulated and returned to the mixing tank 31. Supernatant liquid obtained in the solid-liquid separation tank 33 is filtered by the ceramic membrane 36 to become permeated water because coagulated flocs or particles are removed almost completely. The hole diameter of the ceramic membrane 36 is in the range of 0.1 to 1.0 μm, preferably 0.1 μm. The obtained flux is in the range of about 0.5 to 2 m³/(m²day). The operating pressure is in the range of 5 to 20 m-H₂O. The permeated water is stored in a permeated water tank 37. The water discharged from the permeated water tank 37 is supplied to the copper treatment step 10. The recovery step 12 of the copper treatment step 10 may be performed by a single electrolytic deposition apparatus. The single electrolytic deposition apparatus may be sufficient, if coexistent cation concentration is low or coexistent cation is allowed to continue to be concentrated in the CuSO₄ circulation line. It should be noted that two or more electrolytic deposition apparatuses may be provided in parallel and alternate operation of the electrolytic deposition apparatuses may be performed.

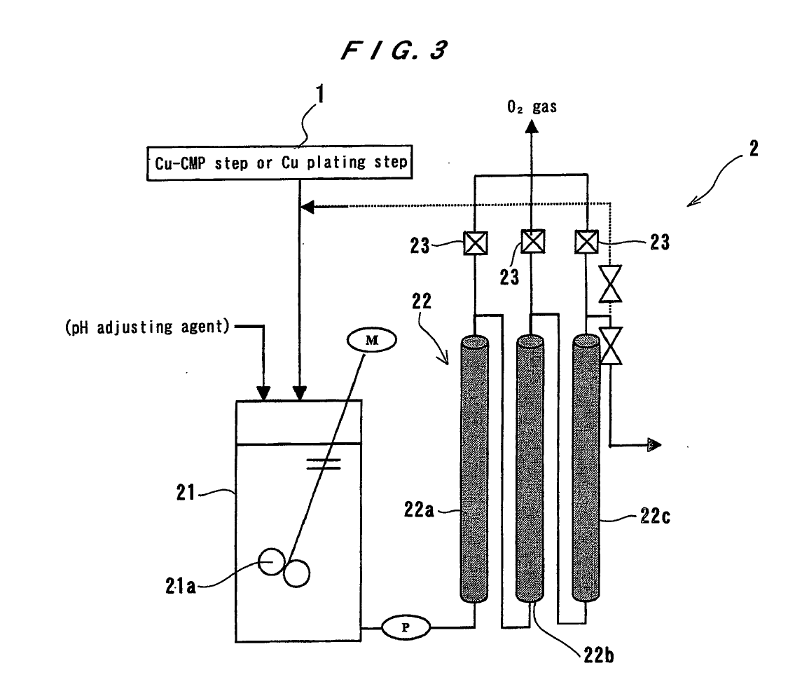

FIG. 3 is a schematic view showing a hydrogen peroxide decomposition step in detail. As shown in FIG. 3, in the hydrogen peroxide decomposition step 2, an adjustment tank 21 and a hydrogen peroxide decomposition tower 22 are provided. The adjustment tank 21 temporarily stores waste water discharged from the Cu-CMP step or the Cu plating step 1 and the adjustment tank 21 serves to suppress variation in water quality and supply the waste water with uniform composition to a subsequent stage. The adjustment tank 21 may be supplied with acid or alkali as a pH adjusting agent. The pH adjustment means that the pH is adjusted to at least 6 or less, preferably 5 or less by adding acid to waste water, in consideration of the fact that copper exists as copper hydroxide, i.e., a solid object in a case where the waste water itself discharged from the Cu-CMP step or the Cu plating step 1 has a high value of pH, so that even copper which is present in a state of copper hydroxide changes into a state of Cu²⁺ ions. Changing the state of copper into Cu²⁺ ions enables the performance of the copper treatment step 10 at the subsequent stage to be kept efficient.

A hydrogen peroxide decomposition tower 22 in the hydrogen peroxide decomposition step 2 comprises three columns 22a, 22b and 22c packed with a platinum-coated metal honeycomb catalyst. The amount of platinum coated by the metal honeycomb catalyst is in the range of 1 to 10 g/l, preferably in the range of 2 to 5 g/l. Cell density (density of honeycomb pores) is in the range of 100 to 1000 cell/square inch, preferably in the range of 200 to 600 cell/square inch. The metal honeycomb catalyst preferably comprises a substrate to which acid resistant coating is applied. The condition for allowing water to pass through the columns 22a, 22b and 22c packed with metal honeycomb catalyst is as follows: LV (linear velocity) is in the range of 10 to 100 m/hour, preferably in the range of 30 to 60 m/hour, and the contact time is in the range of 1 to 10 minutes, preferably in the range of 3 to 5 minutes oxygen gas generated by decomposing hydrogen peroxide into oxygen and water is discharged from the hydrogen peroxide decomposition tower 22 through gas-liquid separation apparatuses 23. After decomposition of hydrogen peroxide, treated water is supplied to the slurry separation step 3, or is directly supplied to the copper treatment step 10 without being passed through the slurry separation step 3. The number of columns in the hydrogen peroxide decomposition tower 22 may be less than 3 if the amount of hydrogen peroxide to be decomposed is small. If the amount of hydrogen peroxide to be decomposed is large, the amount of oxygen gas generated by decomposition of hydrogen peroxide increases, and substantial residence time of water becomes short. Therefore, the number of columns may be three or more for the purpose of separating oxygen gas from the water to be treated.

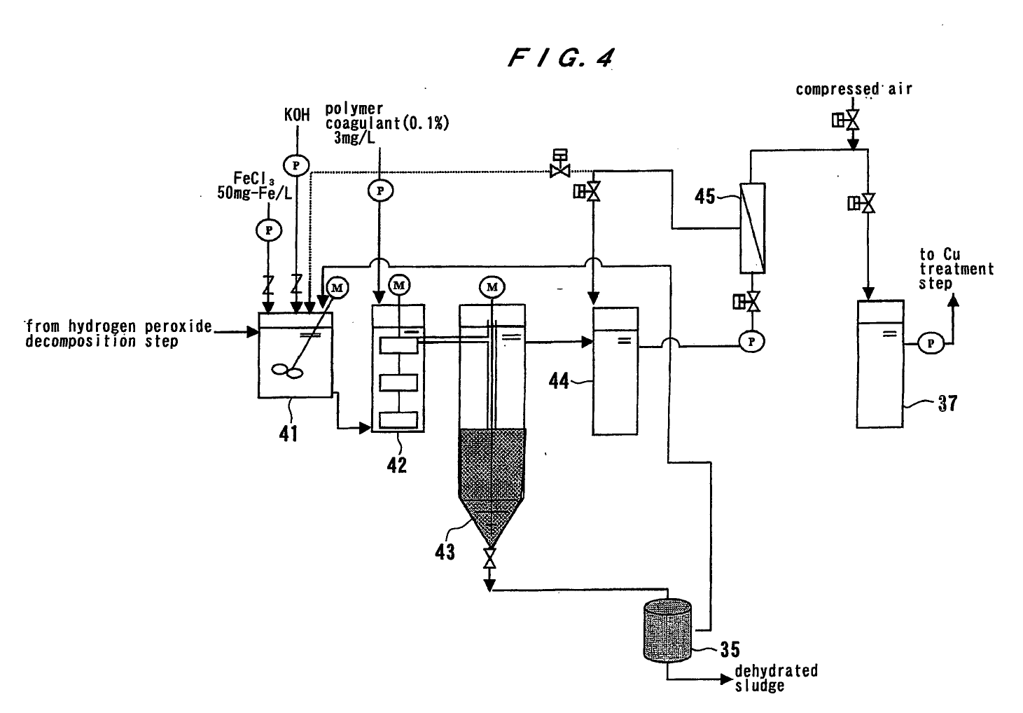

FIG. 4 is a schematic view showing a slurry separation step in detail. As shown in FIG. 4, in the slurry separation step, there are provided a mixing tank 41, a coagulating tank 42, a solid-liquid separation tank 43, a circulation tank 44, a permeated water tank 37 and a ceramic membrane 45.

Treated water which has been treated in the hydrogen peroxide decomposition step is supplied to the mixing tank 41. In the mixing tank 41, FeCl₃ is supplied as inorganic coagulant. At this time, a pH of liquid in the mixing tank 41 becomes about 2.7. However, the treated water is adjusted to a pH of about 5 by supplying alkali. With this adjustment, fine flocs of iron hydroxide are produced. Water discharged from the mixing tank 41 is supplied to the coagulating tank 42.

In the coagulating tank 42, a polymer coagulant (for example, 0.1% solution as raw liquid) is supplied. With this operation, inorganic coagulated flocs are enlarged, and the flocs having good sedimentation can be obtained.

Next, the coagulated flocs produced in the coagulating tank 42 are separated into concentrated sludge and supernatant liquid in the solid-liquid separation tank 43. The solid-liquid separation tank 43 is arranged such that the velocity of upward flow of water is equal to or smaller than the sedimentation velocity of sludge.

The supernatant liquid is supplied to the ceramic membrane 45, and permeated water is stored in the permeated water tank 37. The ceramic membrane is operated such that while water is circulated, part of water is obtained as permeated water which has passed through the membrane, and the flow rate of water which is ten times that of permeated water is circulated. Material of membrane may be organic polymer other than ceramics.

The centrifugal separator 35 used in the slurry separation step comprises a decanter-type centrifugal separator, and concentrated sludge obtained in the solid-liquid separation tank 43 is further concentrated and dehydrated by the centrifugal separator. The centrfigal separator having an acceleration of about 3000 to 5000 G may be used. As a result, dehydrated sludge having a water content of about 85% canbe obtained. Since mother liquid in the separated sludge, i.e. separated water contains Cu, the separated water is returned to the mixing tank 41.

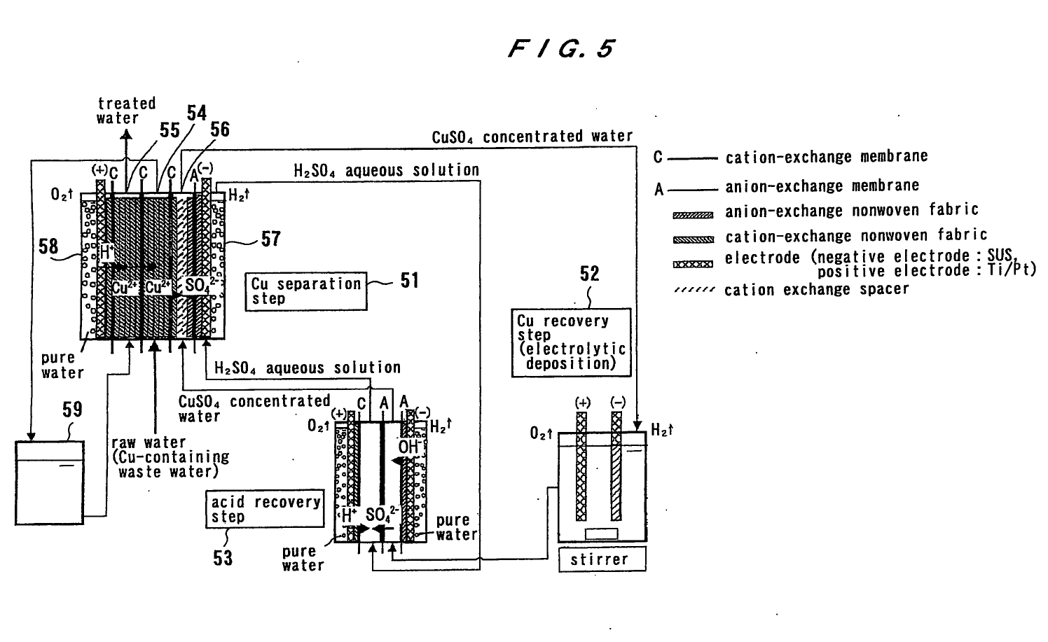

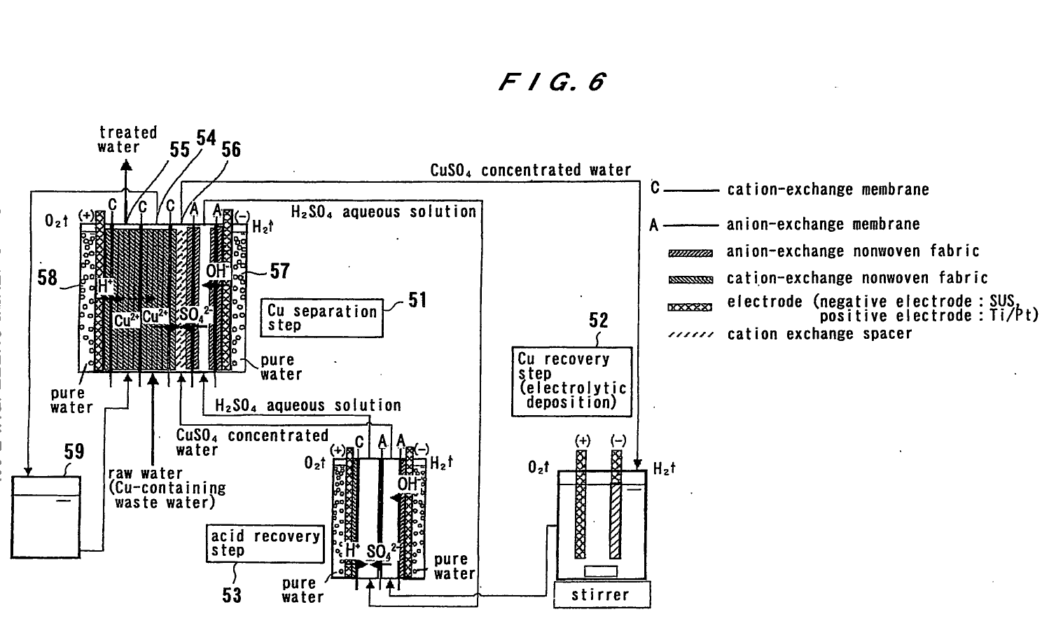

FIGS. 5 and 6 are schematic views showing an example of a copper treatment step.

The copper treatment step 10 shown in FIG. 5 comprises three steps of a Cu separation step 51, a Cu recovery step 52 and an acid recovery step 53, for example.

The Cu separation step 51 serves to separate and recover Cu in raw water as CuSO₄ concentrated water by electrodialysis operation. The electrodialysis apparatus for performing the Cu separation step has five chambers of a first desalting chamber 54, a second desalting chamber 55, a concentrating chamber 56, a cathode chamber 57 and an anode chamber 58.

First, raw water is supplied to the first desalting chamber 54. The first desalting chamber 54 is packed with cation-exchange nonwoven fabric produced by graft polymerization. Further, the first desalting chamber 54 and the adjacent chamber are partitioned by a cation-exchange membrane. When raw water is supplied to the first desalting chamber 54, Cu in the raw water is captured by the cation-exchange nonwoven fabric, and the captured Cu moves to the concentrating chamber 56 by a potential gradient between a positive electrode and a negative electrode. Cations other than Cu contained in the raw water behave like Cu. Water discharged from the first desalting chamber 54 is temporarily stored in an intermediate tank 59, and water discharged from the intermediate tank 59 is supplied to the second desalting chamber 55. The intermediate tank is not necessarily provided. If the intermediate tank is not provided, the water discharged from the first desalting chamber 54 is directly supplied to the second desalting chamber 55.

The second desalting chamber 55 is packed with cation-exchange nonwoven fabric produced by cation-exchange graft polymerization in the same manner as the first desalting chamber 54. With this arrangement, Cu leaking out from the first desalting chamber (intermediate desalting chamber) 54 is also captured and removed in the second desalting chamber 55, and the captured Cu can be finally moved through the first desalting-chamber 54 to the concentrating chamber 56 by a potential gradient. The second desalting chamber 55 and the adjacent chamber are partitioned by a cation-exchange membrane. Water discharged from the second desalting chamber 55 becomes treated water finally. Here, a gas such as air may be added to inflow water of the first and second desalting chambers 54, 55. In a case where slurry is captured by the surface of the cation-exchange nonwoven fabric, the strong fluidity generated by adding the gas has an effect of removing the captured slurry from the cation-exchange nonwoven fabric. By performing such injection operation of the gas periodically, clogging of the desalting chamber and coating of slurry on the surface of the cation-exchange nonwoven fabric can be suppressed, and hence Cu in the raw water can be treated steadily.

In the concentrating chamber 56, Cu ions supplied from the first desalting chamber 54 and the second desalting chamber 55 are mixed with SO₄²⁻ supplied from sulfuric acid filled in the cathode chamber 57 to produce CuSO₄ concentrated water, and the produced CuSO₄ concentrated water is supplied to the Cu recovery step 52. In the Cu separation step 51, current condition is as follows: Constant current operation is performed and current density is set in the range of 1 to 4 A (ampere)/dm², preferably about 3 A/dm². In this case, voltage is in the range of 10 to 40 V. The thicknesses of the desalting chamber and the concentrating chamber are in the range of 3 to 10 mm, preferably in the range of 3 to 5 mm.

Further, the sulfuric acid is added so that the CuSO₄ concentrated water is adjusted to a pH of not more than 2, preferably not more than 1.5. The CuSO₄ concentrated water has a copper concentration of 500 to 3000 ppm, preferably about 1000 ppm. If the copper concentration is not more than 500 ppm, a Cu deposition rate in the Cu recovery step is low, and hence an area of the electrode required for deposition becomes large, resulting in a large-sized apparatus. If the copper concentration is not less than 3000 ppm, the difference of copper concentration between the concentrating chamber and the first desalting chamber in the Cu separation step becomes too large, resulting in a lowering of efficiency due to generation of back-diffusion. If the deposition ability of copper in the Cu recovery step is larger than the concentration ability of copper in the Cu separation step, the copper concentration of the CuSO₄ concentrated water may be lower than the copper concentration of the raw water. The pH in the H₂SO₄ circulation line is not more than 2.0, preferably not more than 1.5. The pH adjustment of liquid in the CuSO₄ concentrated water circulation line or the H₂SO₄ circulation line is performed by adjusting current value supplied to the electrodialysis apparatus for carrying out the acid recovery step or by adding sulfuric acid.

In the Cu recovery step 52, copper is recovered as Cu metal on a surface of the cathode by electrolytic deposition operation. As shown in FIG. 1, in the Cu recovery step 52, two or more electrolytic deposition apparatuses maybe provided in parallel, and alternate operation of the electrolytic deposition apparatuses may be performed. Alternatively, as shown in FIG. 2, a single electrolytic deposition apparatus may be provided. The acid recovery step 53 serves to return SO₄²⁺ ions concentrated in the CuSO₄ concentrated water circulation line by electrodialysis operation to the H₂SO₄ circulation line. The chamber to which CuSO₄ concentrated water is supplied and the chamber to which sulfuric acid aqueous solution is supplied are separated from each other by an anion-exchange membrane, and SO₄²⁻ is moved from the CuSO₄ concentrated water to the sulfuric acid aqueous solution by applying a potential between the positive electrode and the negative electrode. In this manner, by recovering SO₄²⁻, the SO₄²⁻ concentration in the CuSO₄ concentrated water circulation line and the H₂SO₄ circulation line can be a steady concentration. The thickness of each chamber except for an electrode chamber is in the range of 3 to 10 mm, preferably 3 to 5 mm.

The current density in the acid recovery apparatus provided in the acid recovery step 53 is 2 to 3 A/dm². Although a single acid recovery apparatus is provided in FIG. 5, in some cases, a plurality of acid recovery apparatuses are required depending on the ability of the acid recovery step 53. In these cases, a plurality of acid recovery apparatuses having the same structure may be arranged in parallel. Further, if the installation space of the apparatus should be small, a bipolar type apparatus may be used to increase a processing ability per one apparatus.

A copper treatment step shown in FIG. 6 is different from the copper treatment step shown in FIG. 5 in that a cell in the Cu separation step 51 has a chamber between the concentrating chamber 56 and the cathode chamber 57 for allowing sulfuric acid aqueous solution to circulate therethrough, and the cathode chamber 57 is packed with pure water. This structure allows OH⁻ generated in the cathode chamber 57 to flow directly into the concentrating chamber 56, so that the phenomena of depositing of Cu(OH)₂ in the concentrating chamber 56 can be suppressed. Further, it is possible to suppress a demerit that pressure is applied to a circulating path of liquid or ion-exchange function is impaired because an ion exchanger and an ion exchange membrane are covered with Cu(OH)₂. In FIGS. 5 and 6, pure water may be continuously supplied to the electrode chamber or circulated through the electrode chamber. A filtering facility comprising a filter for filtering outflow water of the Cu recovery step may be provided to remove fine powder of Cu metal produced in the Cu deposition step.

If an installation space of the Cu separation step 51 should be small, a bipolar type apparatus may be provided in the same manner as the acid recovery step 53.

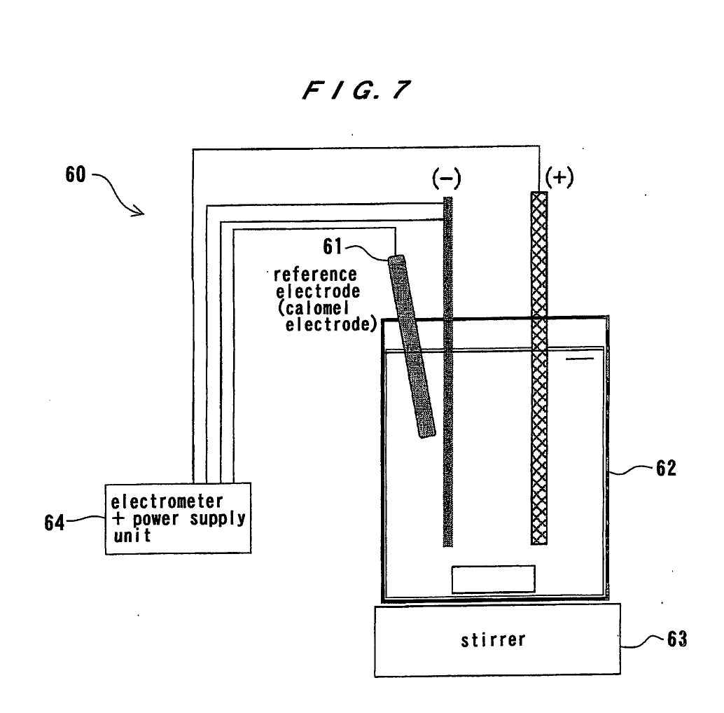

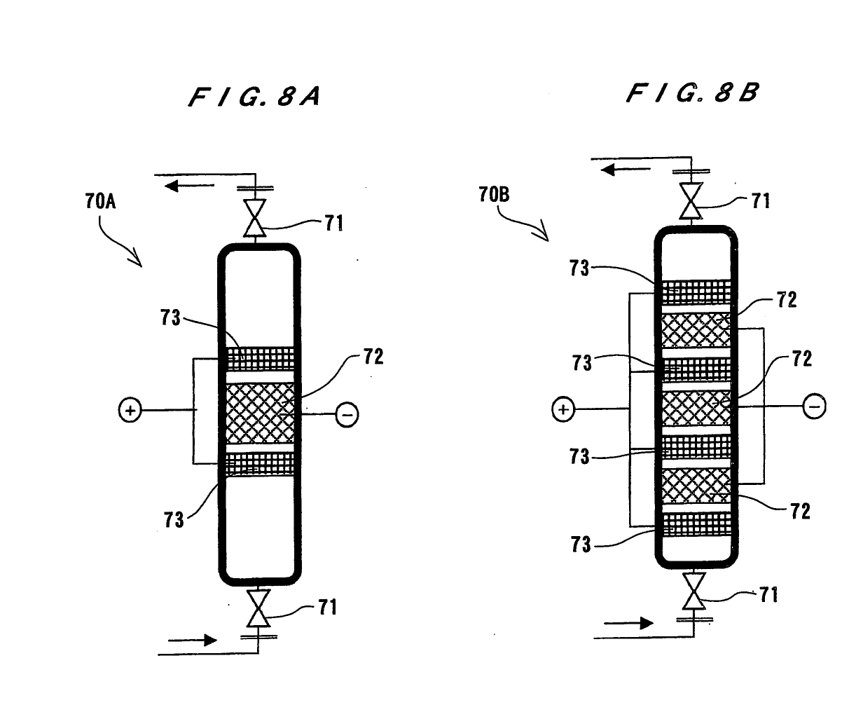

FIGS. 7, 8A and 8B are schematic views showing an electrolytic deposition apparatuses. FIG. 7 shows an electrolytic deposition apparatus according to a first embodiment of the present invention, and FIG. 8A and 8B show electrolytic deposition apparatuses according to a second embodiment of the present invention.

Referring to FIG. 7, the manner in which electric current flows in the Cu deposition step (Cu recovery step) by an electrolytic deposition apparatus 60 according to the first embodiment will be described. In FIG. 7, the reference numeral 61 represents a reference electrode such as a calomel electrode, the reference numeral 62 represents an electrolytic deposition bath, the reference numeral 63 represents a stirrer, and the reference numeral 64 represents a power supply unit. Applying electric current in the Cu deposition step is roughly classified into three methods of constant current operation, constant voltage operation and constant potential operation. Any method may be employed. In FIG. 7, the constant potential operation will be described.

In the constant potential operation, the cathode potential is measured by the reference electrode, and current value is adjusted so that the cathode potential is kept constant at a predetermined value. In this case, generation of OH⁻ and a lowering of current efficiency caused by electrolysis of water can be suppressed. As operating conditions, the cathode potential should be set to −0.3 to 0.2 (V), preferably −0.1 to 0.1 (V).

It is desirable that liquid in the electrolytic deposition bath 62 is stirred by a pump or a stirrer. Alternatively, liquid in the electrolytic deposition bath 62 may be stirred by a rotary motion of the cathode or the anode.

FIG. 8A and 8B are schematic views showing the electrolytic deposition apparatuses 70A and 70B according to a second embodiment of the present invention.

In a semiconductor device fabrication plant, not only a concentration of Cu but also a concentration of foreign matter should be as small as possible, i.e., a high cleanliness of atmosphere is required. If the cathode is replaced with new one in such a state that Cu metal is exposed to the atmosphere, there is a possibility of causing Cu contamination.

Both of electrolytic deposition apparatuses 70A and 70B shown in FIGS. 8A and 8B comprise a cartridge-type apparatus, and the cartridge is replaced entirely after closing the upper and lower valves 71, and hence the cathode on which Cu is deposited sufficiently can be replaced without exposing the Cu metal. With this arrangement, the replacement work can be easily carried out.

The electrolytic deposition apparatus 70A has a single cathode 72. The electrolytic deposition apparatus 70B has a plurality of cathodes 72 for the purpose of prolonging a service life of the cartridge. It is desirable for both of the anode 73 and the cathode 72 to have water-permeability and gas-permeability. As the cathode 72, foamed metal or net-like electrode or lath plate-like electrode may be used. Further, as the anode 73, the same structure or the same material may be employed. A plurality of cartridges maybe provided in a single system, and may be arranged in series or in parallel.

The electrolytic deposition apparatuses 70A and 70B may comprise a cartridge-type apparatus as shown in FIGS. 8A and 8B. However, the electrolytic deposition apparatus may comprise other-type apparatuses, and the known-type apparatuses may be employed.

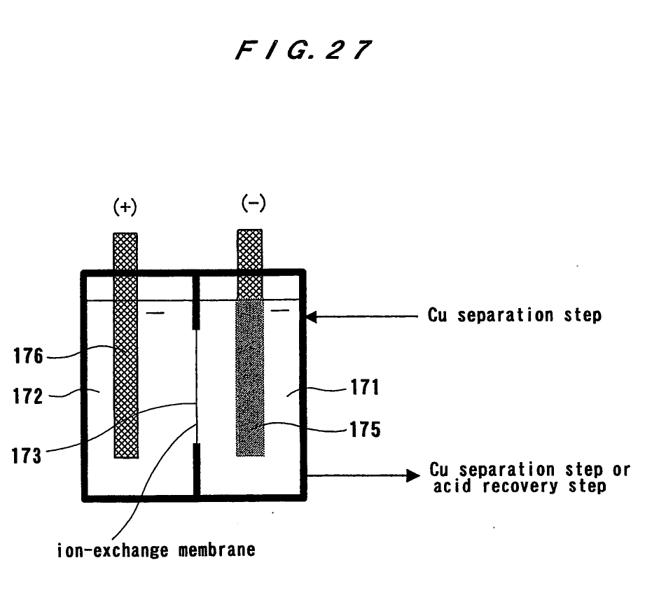

The electrolytic deposition apparatus may use a method for scraping copper deposited on the surface of the cathode by a scraper, and recovering the copper into a bag filter. If the electrolytic deposition apparatus comprises a membrane combined-type electrolytic deposition apparatus, as shown in FIG. 27, which has a water tank 171 in which a cathode 175 is provided, a water tank 172 in which an anode 176 is provided, and an ion-exchange membrane 173 which separates the water tank 171 and the water tank 172, then the CuSO₄ concentrated water is supplied only to the water tank 171 in which the cathode 175 is provided.

As an ion-exchange fibrous material which can be used for the electrodialysis operation, it is preferable to use a fibrous material comprising polymer fibers as substrates to which ion-exchange groups are introduced by graft polymerization. The substrates of polymer fibers to be grafted may either be single fibers of a polyolefine such as polyethylene or polypropylene, or composite fibers comprising a core portion and a sheath portion in which the core portion and the sheath portion are made of different polymers respectively.

Example of composite fibers which can be used in the present invention is composite fibers having a core-sheath structure in which a polyolefin such as polyethylene constitutes the sheath and other polymer such as polypropylene which is not used for the sheath constitutes the core. The ion-exchange fibrous materials, which are obtained by introducing ion-exchange groups into the composite fibers by a radiation-induced graft polymerization, are excellent in the ion-exchange ability and can be produced with a uniform thickness, and therefore are desirable as ion-exchange fibrous materials to be used for the above object. The ion-exchange fibrous material may be in the form of a woven fabric, nonwoven fabric, and the like.

As an ion exchanger in the form a spacer member such as a diagonal net, an ion exchanger comprising a polyolefin resin is preferably used for its excellent ion exchange ability and excellent ability to disperse the water to be treated. For example, a polyethylene diagonal net which is widely employed in electrodialysis baths is used as substrates and ion-exchange ability is imparted by utilizing a radiation-induced graft polymerization, then desirable ion exchanger is obtained.

The radiation-induced graft polymerization is a technique for introducing a monomer into polymer substrates by irradiating the polymer with radiation rays so as to produce a radical which reacts with the monomer.

Radiation rays usable for the radiation-induced graft polymerization include α-rays, β-rays, γ-rays, electron beam, ultraviolet rays, and the like. Of these, γ-rays or electron beam may preferably be used in the present invention. As the radiation-induced graft polymerization, there are a pre-irradiation graft polymerization comprising previously irradiating graft substrates with radiation rays and then contacting the substrates with a grafting monomer, and a co-irradiation method in which irradiation of radiation rays is carried out in the co-presence of substrates and a grafting monomer. Both of these methods may be employed in the present invention.

Further, depending upon the manner of contact between a monomer and substrates, there are polymerization methods such as a liquid-phase graft polymerization method in which polymerization is effected while substrates are immersed in a monomer solution, a gas-phase graft polymerization method in which polymerization is effected while substrates are in contact with vapor of monomer, and an immersion gas-phase graft polymerization method in which substrates are firstly immersed in a monomer solution and then taken out of the monomer solution and a polymerization is effected in a gas phase. Either method of polymerization may be employed in the present invention.

The ion-exchange groups to be introduced into fibrous substrates such as a nonwoven fabric, or into spacer substrates are not particularly limited. Various kinds of cation-exchange groups and anion-exchange groups can be used. For instance, usable cation-exchange groups include strongly acidic cation-exchange groups such as sulfo group, moderately acidic cation-exchange groups such as phosphoric group, and weakly acidic cation-exchange groups such as carboxy group. Usable anion-exchange groups include weakly basic anion-exchange groups such as primary, secondary and tertially amino groups, and strongly basic anion-exchange groups such as quaternary ammonium group. Further, an ion exchanger having both of the above-described cation and anion groups may also be employed. Furthermore, it is also possible to use an ion exchanger having functional groups such as functional groups derived from iminodiacetic acid or its sodium salt, functional groups derived from various amino acids including phenylalanine, lysine, leucine, valine, proline or their sodium salts or functional groups derived from iminodiethanol.

These various ion-exchange groups can be introduced into fibrous substrates or spacer substrates by subjecting a monomer having such an ion-exchange group to graft polymerization, preferably radiation-induced graft polymerization, or by subjecting a polymerizable monomer having a group that are changeable into an ion-exchange group, to graft polymerization, followed by conversion of that group into the ion-exchange group.

Monomers having an ion-exchange group usable for this purpose may include acrylic acid (AAc), methacrylic acid, sodium styrenesulfonate (SSS), sodium methallylsulfonate, sodium allylsulfonate, sodium vinylsulfonate, vinylbenzyl trimethylammonium chloride (VBTAC), diethylaminoethyl methacrylate, and dimethylaminopropylacrylamide.

Sulfo group as a strongly acidic cation-exchange group, for example, may be introduced directly into substrates by carrying out radiation-induced graft polymerization in which sodium styrenesulfonate is used as a monomer. Quaternary ammonium group as a strongly basic anion-exchange group may be introduced directly into substrates by carrying out radiation-induced graft polymerization in which vinylbenzyl trimethylammonium chloride is used as a monomer.

The monomer having groups that can be converted into ion-exchange groups may include acrylonitrile, acrolein, vinylpyridine, styrene, chloromethylstyrene, and glycidyl methacrylate (GMA). Sulfo group as a strongly acidic cation-exchange group, for example, may be introduced into substrates in such a manner that glycidyl methacrylate is introduced into the substrates by radiation-induced graft polymerization, and then react with a sulfonating agent such as sodium sulfite. Quaternary ammonium group as a strongly basic anion-exchange group may be introduced into substrates in such a manner that chloromethylstyrene is graft-polymerized onto substrates and then the substrates are immersed into an aqueous solution of trimethylamine to effect quaternary-ammonification.

Further, sodium iminodiacetate group as a functional group can be introduced into substrates in such a manner that chloromethylstyrene is graft-polymerized onto substrates and the substrates react with a sulfide to make a sulfonium salt, and then the sulfonium salt reacts with sodium iminodiacetate. Alternatively, sodium iminodiacetate as a functional group may be introduced into substrates in such a manner that chloromethylstyrene is graft-polymerized onto substrates and chloro group is substituted with iodine group and iodine group reacts with an iminodiacetic acid diethyl ester to substitute iodine group with an iminodiacetic acid diethyl ester group, and finally the ester group reacts with sodium hydroxide to convert the ester group into sodium salt.

Among the above-described various forms of ion exchangers, an ion-exchange fibrous material in the form of a nonwoven fabric or a woven fabric is particularly preferable. A fibrous material, such as a woven fabric or a nonwoven fabric, as compared to materials in the form of beads, a diagonal net, and the like has a remarkably larger surface area, and therefore a larger amount of ion exchange groups can be introduced thereinto. Further, unlike the case of resin beads in which ion-exchange groups are present in micropores or macropores within the beads, all the ion-exchange groups are present on the surfaces of fibers in the case of an ion-exchange fibrous material. Accordingly, metal ions in the water to be treated can easily diffuse into the vicinity of ion-exchange groups, and the ions are adsorbed by means of ion exchange. Therefore, the use of an ion-exchange fibrous material can thus improve removal and recovery efficiency of metal ions.

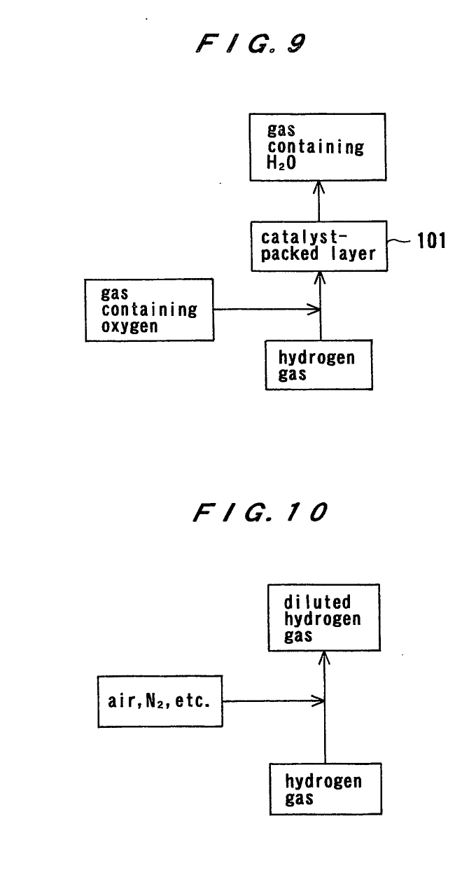

For treating hydrogen gas generated, the following methods may be employed as shown in FIGS. 9 through 11: A method in which hydrogen gas is mixed with a gas containing an equimolar or more oxygen, and the mixed gas is passed through a catalyst-packed layer 101, which is capable of recombining the hydrogen gas and the oxygen gas to produce water, to cause catalytic reaction, thereby making the concentration of the remaining hydrogen gas less than 4% by volume which is the explosion limit concentration (see FIG. 9); a method in which hydrogen gas is mixed with a large amount of air, an inert gas (such as N₂), and the like to lower the hydrogen concentration to less than the explosion limit concentration (see FIG. 10); and a method in which hydrogen gas is supplied to a fuel cell 102 (see FIG. 11). In the case of using the fuel cell 102, the electric energy (electric power) obtained may be utilized for the operation of waste water treatment facilities 103 or other facilities.

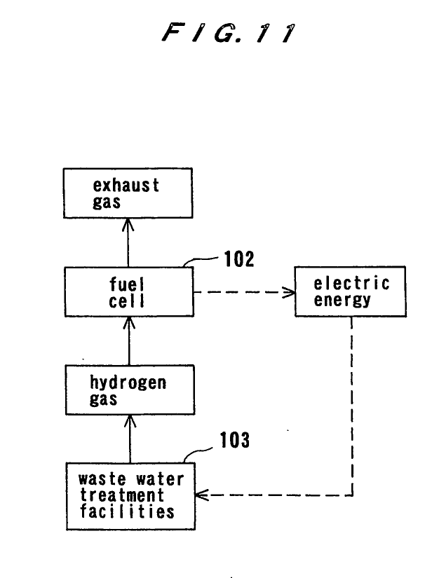

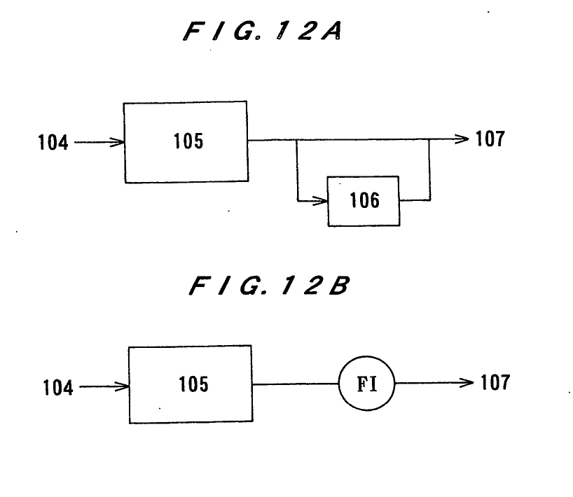

A method for monitoring the quality or quantity of treated water obtained by the above-described waste water treatment apparatus according to the present invention and detecting its abnormality will be described with reference to FIGS. 12A and 12B. In FIGS. 12A and 12B, the reference numeral 105 denotes a waste water treatment apparatus according to any one of the above-described embodiments of the present invention, 104 denotes water to be treated, and 107 denotes treated water.

According to a first method, as shown in FIG. 12A, the concentration of copper ions of the treated water 107 obtained from the waste water treatment apparatus 105 according to the present invention is measured by means of a copper ion concentration measurement device 106. The measurement device maybe designed such that it gives an alarm when the concentration of copper ions of the treated water becomes higher than a set value. In this case, a shortage of electric current in the electrolytic deposition apparatus or the electrodialysis apparatus, an increase in the concentration of copper ions of the raw water, and deterioration of an ion exchanger due to electrodialysis treatment maybe considered as the causes. These maybe dealt with by a rise of operation current in the electrolytic deposition apparatus or electrodialysis apparatus, replacement of the ion exchanger, or the like.

Copper ion concentration measurement devices usable for this purpose may include measuring devices based on ion-selective electrode, electrode polarography, HPLC electrophoresis, fluorometry, etc. Although the copper ion concentration measurement device 106 is provided in a line branched from the treated water line, the copper ion concentration measurement device 106 may be provided in the treated line.

Further, as shown in FIG. 12B, the flow rate of treated water 107 obtained from the waste water treatment apparatus 105 according to the present invention, may be measured with a flow indicator (FI). When the amount of treated water becomes lower than a set value, the apparatus may give an alarm. In this case, clogging of ion exchanger, shortage of introduction pressure of water at the water inlet, and the like may be considered as the causes. These may be dealt with respectively by replacement of ion exchanger, a rise of pressure of water at the water inlet, etc. These countermeasures may be executed by automatic control effected in conjunction with measured values obtained in the measuring device.

A polishing liquid for use in the CMP process can contain as an additive an oxidizing agent, such as hydrogen peroxide, iron nitrate, sodium persulfate or ammonium persulfate. Further, after forming a copper film on the surface of a wafer in a copper plating process, the copper film adhering to a peripheral portion (edge portion) of the wafer or to the back surface of the wafer can peal off and contaminate the clean room. Accordingly, a so-called bevel-etching is carried out to remove the copper film adhering to the peripheral portion or the back surface of the wafer by dissolving the copper film with an acid, such as hydrochloric acid, sulfuric acid, citric acid or oxalic acid while oxidizing the copper film with an oxidizing agent such as hydrogen peroxide.

Waste water from a CMP, an ECP, or a copper plating process used for forming copper interconnections thus frequently contains, besides a large amount of copper ions, an oxidizing agent such as hydrogen peroxide. Such an oxidizing agent, particularly hydrogen peroxide, can be easily decomposed by electrolysis, and electrolysis of hydrogen peroxide progresses in preference to electrolytic deposition of a heavy metal such as copper. If a large amount of hydrogen peroxide is contained in waste water, a larger electric current is required for electrolytic deposition.

Further, if an oxidizing agent such as hydrogen peroxide is contained in the water to be treated, the problem of lowering of the function of ion exchanger arises. In addition, there is a fear of re-dissolution of the deposited metal, hydroxide or oxide. It is, therefore, preferred to construct a waste water treatment system including equipment for removing or reducing hydrogen peroxide.

FIG. 13 shows an embodiment of a treatment system for waste water from a semiconductor device fabrication processes in view of the above. According to the system shown in FIG. 13, waste water from various processes 108, such as a CMP process, an ECP process, and a copper plating process, is first treated in an oxidizing agent removing step 109, and then treated in a waste water treatment apparatus 110 according to the present invention which employs electrolytic deposition operation and electrodialysis operation in combination. The reference numeral 111 denotes treated water.

FIG. 14 shows a relationship between a CMP apparatus and a waste water treatment system according to the present invention. The CMP apparatus 112 includes a polishing unit (a polishing step) 112a and a cleaning unit (a cleaning step) 112b. In the polishing step 112a, a wafer is polished.

Liquids, such as pure water and a chemical liquid(s) containing a slurry, a dispersant, an acid, an alkali, a chelating agent, etc., are used in the polishing step 112a. Waste water from such liquids is introduced into the waste water treatment system (the waste water treatment apparatus) 110.

In the cleaning step 112b, the slurry, abrasive particles and the chemical liquid remaining on the wafer are cleaned off with pure water, etc. Such a cleaning waste water is also introduced into the waste water treatment system. The polishing unit 112a may be one that performs electrochemical polishing. Substances peculiar to the waste water discharged from the polishing step 112a and the cleaning step 112b is contained therein. In a case where such substances impede the waste water treatment, it is possible to remove the impediments in advance by means of a chemical treatment 112c, a solid-liquid separation treatment 112d, etc. (for example, separation of SS produced by edge-chipping, and dissolution or separation of a metal powder). The polishing step and the cleaning step are performed in multistage, respectively, in some cases.

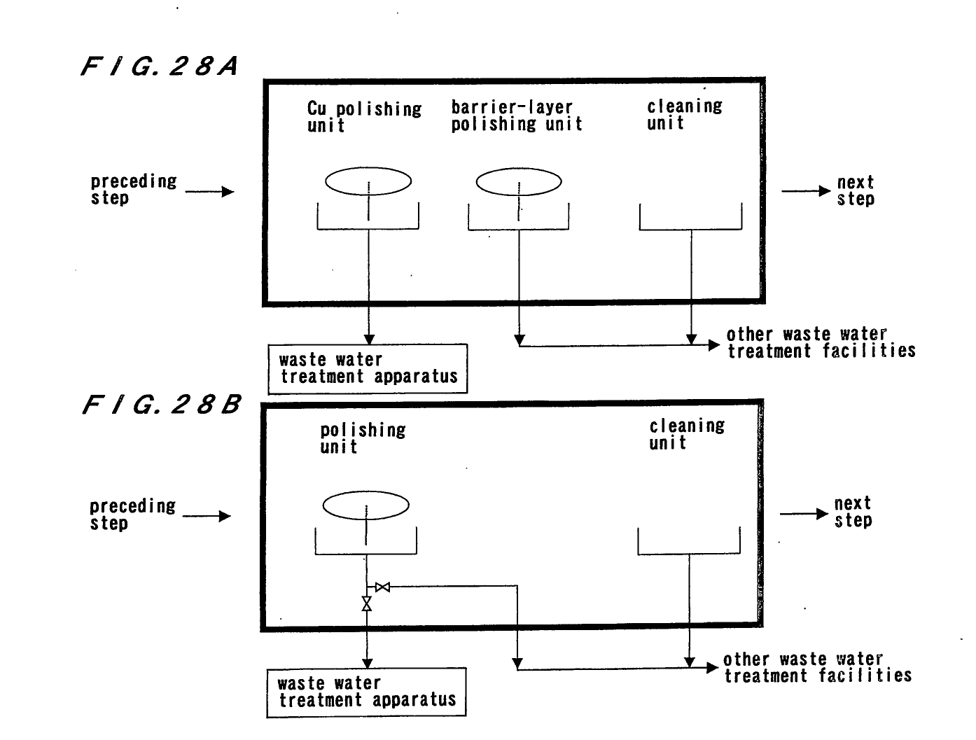

If the polishing step comprises a Cu polishing step and other steps such as a barrier-layer polishing step than the Cu polishing step, and most of discharged Cu is derived from the Cu polishing step, then it is desirable that waste water discharged only from the Cu polishing step is treated by the waste water treatment apparatus according to the present invention. In the Cu-CMP apparatus shown in FIG. 28A, waste water discharged only from the Cu polishing unit can be treated. In the Cu-CMP apparatus shown in FIG. 28B, by switching the draining line of the polishing unit automatically depending on the type of the polishing step, waste water discharged only from the Cu polishing unit can be treated.

FIG. 15 shows a case of introducing waste water discharged from an apparatus that carries out etching and cleaning steps, or plating, etching and cleaning steps in the same chamber into a waste water treatment system. In the apparatus 113 shown in FIG. 15, an etching step and a cleaning step, or a plating step, an etching step and a cleaning step are performed in the same chamber 13a.

An electrochemical method, such as electrochemical polishing, may be used in the etching step. Chemical mechanical polishing (CMP) may also be used. It is possible to introduce all the waste water from the respective steps into the waste water treatment system (the waste water treatment apparatus 110), or to introduce only the waste water from part of the steps into the waste water treatment apparatus 110.

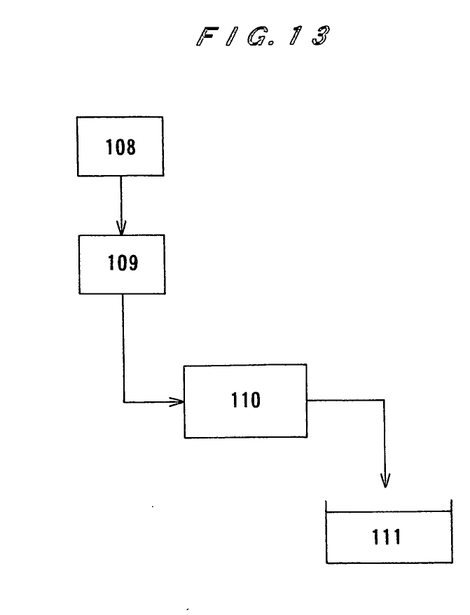

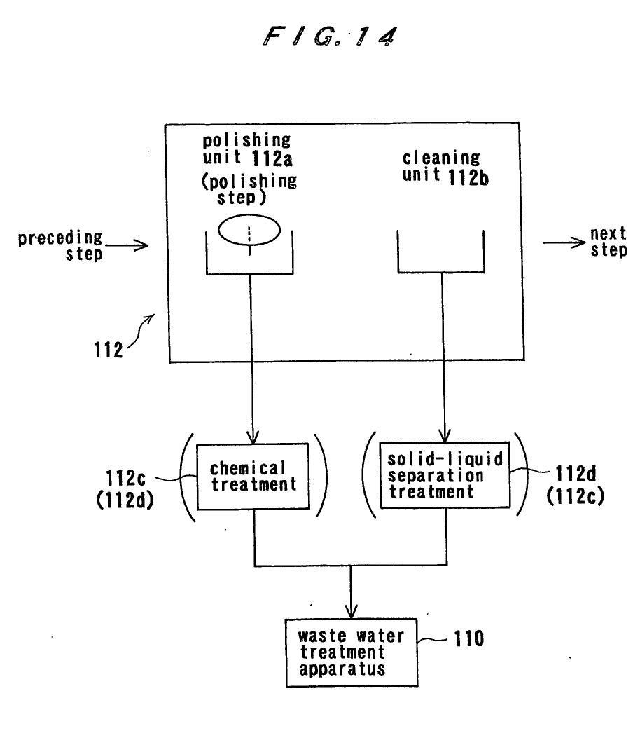

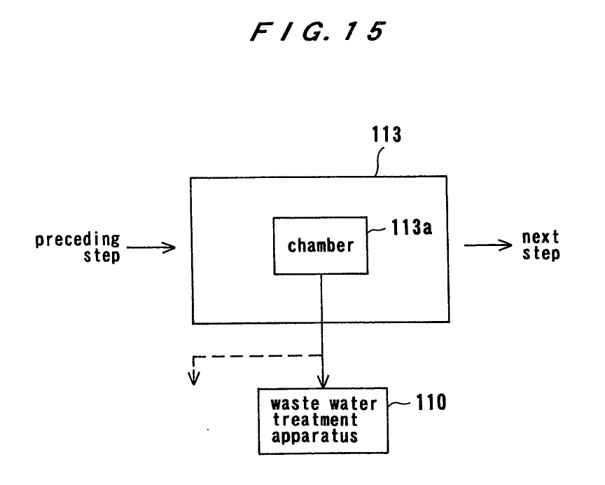

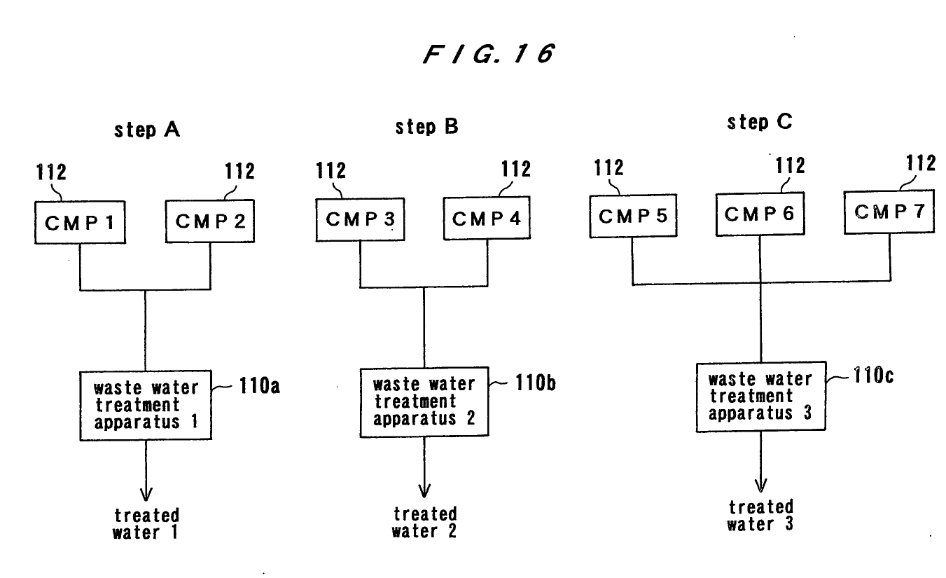

FIG. 16 shows a case of collectively treating waste water discharged from a plurality of apparatuses that perform an identical step. For example, of waste water from polishing apparatuses such as CMP apparatuses 112, waste water from a group of apparatuses that perform a certain identical step (for example, step A) is collectively introduced into a waste water treatment apparatus 110a according to the present invention. Of waste water from CMP apparatuses 112, waste water from another group of apparatuses that perform a different step (for example, step B or step C) is collectively treated separately in a waste water treatment apparatus 110b or 110c.

FIG. 17 is a perspective view showing a waste water treatment unit (a waste water treatment system) provided within a casing. FIG. 17 shows a waste water treatment unit 113 that may be provided with at least one of a pH adjustment device (pH adjustment unit) 113b, an internal negative pressure-forming device, a waste water-receiving tank, a caster for movement, and the like within a casing 114. The internal negative pressure-forming device may be one that is controlled by pressure indicator signals. The casing 114 may be a dividable one. The waste water treatment unit 113 having the above structure can be installed in a space that requires a certain high level of cleanness, such as a clean room or its downstairs space.

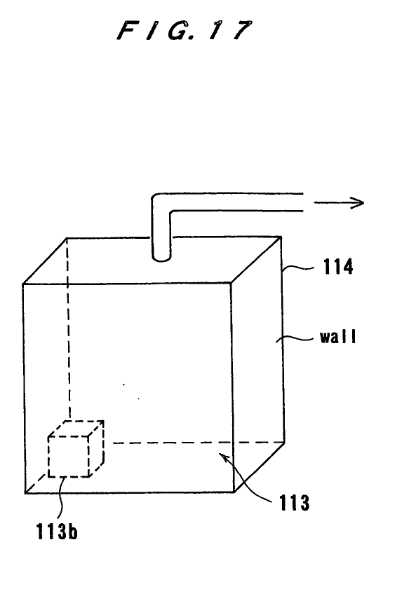

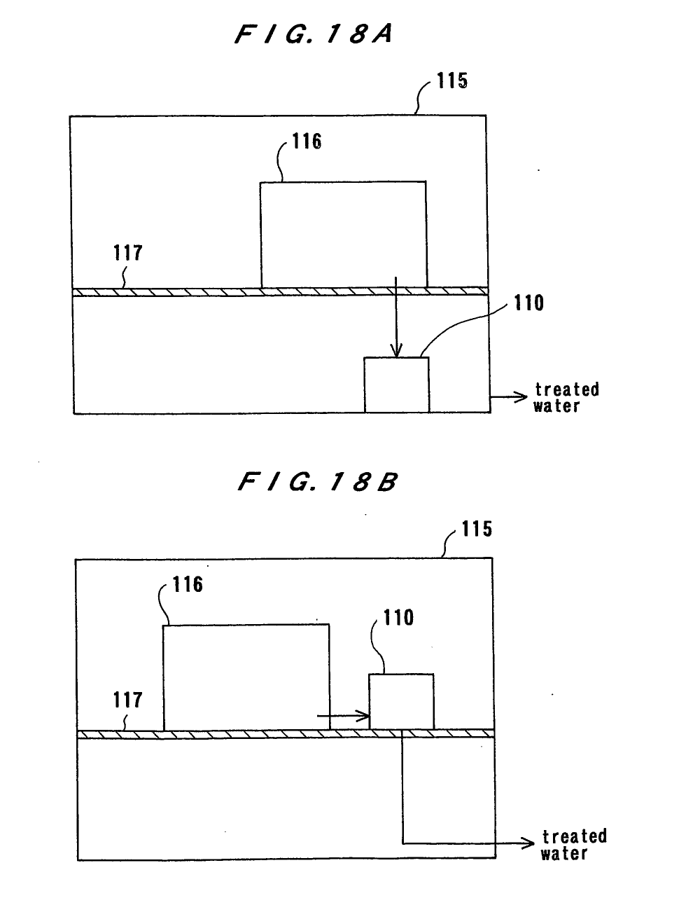

FIGS. 18A and 18B show preferable positional relationships between a CMP apparatus, an ECP apparatus or a plating apparatus and a waste water treatment system according to the present invention. In FIGS. 18A and 18B, the reference numeral 115 denotes a clean room. In FIG. 18A, the waste water treatment apparatus 110 is installed right below a semiconductor manufacturing apparatus 116 (a plating apparatus 118 or a CMP apparatus 112) via a grating 117. In FIG. 18B, the waste water treatment apparatus 110 is installed adjacent to a semiconductor manufacturing apparatus 116.

By installing the waste water treatment apparatus close to the manufacturing apparatus 116 as in the above cases, the facility cost (e.g. piping cost) can be reduced and the volume (size) of the entire factory can be made compact, thus reducing a construction cost of the entire factory.

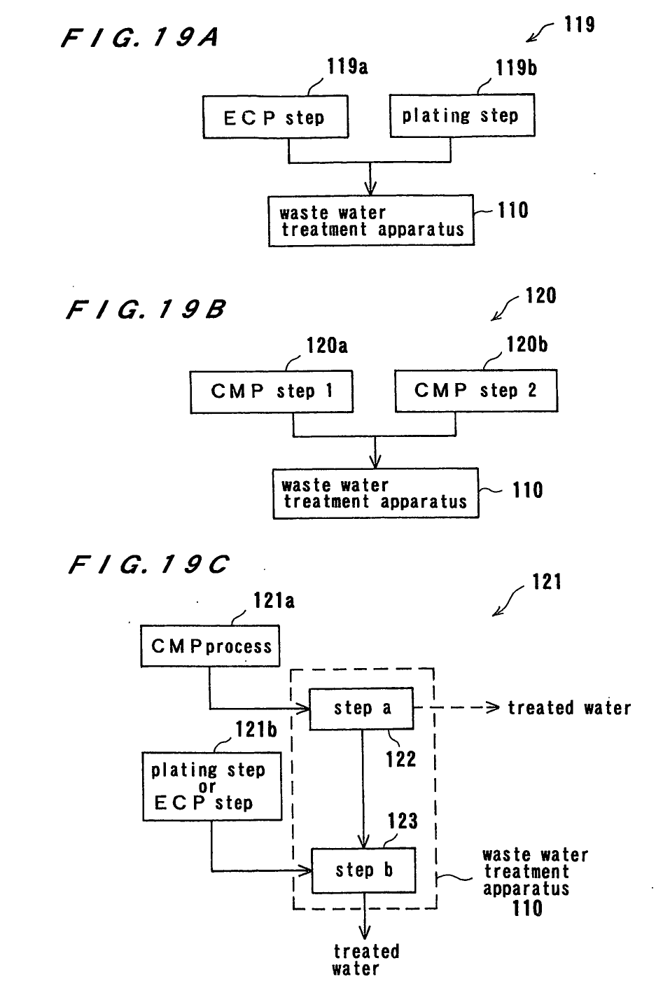

FIGS. 19A through 19C show cases of collectively treating waste water discharged from apparatuses that perform different process steps. For example, as shown in FIG. 19A, waste water discharged from an electrochemical polishing treatment step (ECP step) 119a and waste water discharged from a plating step 119b may be mixed and treated in the waste water treatment system (the waste water treatment apparatus 110).

As shown in FIG. 19B, waste water from apparatuses 120 that operate in the same manner but perform different steps (for example, CMP steps 120a, 120b) may be mixed and treated in the waste water treatment apparatus 110.

As shown in FIG. 19C, it is also possible to introduce waste water with various natures discharged from a CMP process 121a and a plating step or a ECP step 121b into different treatment steps (for example, step 122 and step 123) of the waste water treatment system (the waste water treatment apparatus 110). Treated water may be withdrawn separately from different steps 122 and 123.

In the systems as shown in FIG. 13, the waste water treatment apparatus may be arranged in two lines. By switching the lines upon exchange of replacement parts, such as an ion exchanger and a cathode of the electrolytic deposition apparatus, it becomes possible to secure a continuous treatment.

For example, in the system of FIG. 20, waste water from various processes 108 of semiconductor device fabrication processes is first received in a waste water tank 124, then subjected to the oxidizing agent removing step 109, and is then supplied to one of the two waste water treatment apparatuses 110 according to the present invention which employ electrolytic deposition operation and electrodialysis operation in combination, where copper ions are removed to obtain treated water 111. At the time of exchange of replacement parts, such as the cathode of the electrolytic deposition apparatus and the ion exchanger of the electrodialysis apparatus, the line is switched to allow the water to be treated to pass through the other waste water treatment apparatus 110, while exchange of the replacement parts of the apparatus, to which water supply is stopped, is made. A continuous treatment of the waste water is thus secured.

FIGS. 21A and 21B show installation methods of the waste water treatment system according to embodiments of the present invention in the case of using the waste water treatment system in an actual semiconductor device fabrication plant. In FIGS. 21A and 21B, the reference numeral 130 denotes a semiconductor device fabrication plant, 131 denotes a copper plating apparatus, 132 denotes a polishing apparatus, such as a CMP or ECP apparatus, and 133 denotes a waste water treatment apparatus or waste water treatment system according to any one of the above-described various embodiments of the present invention.

For example, as shown in FIG. 21A, waste water, from the copper plating apparatus 131 and the polishing apparatus 132 such as a CMP or ECP apparatus in the semiconductor device fabrication plant 130, is collected, and the collected waste water is treated by means of the waste water treatment apparatus or waste water treatment system 133 according to any one of the various embodiments of the present invention, whereby treated water 111, from which copper ions such as copper have been removed, can be obtained.

Alternatively, as shown in FIG. 21B, waste water from the copper plating apparatus 131 and waste water from the polishing apparatus 132 such as a CMP or ECP apparatus, are collected separately, and the separately collected waste water is treated separately by means of the waste water treatment apparatus or waste water treatment system 133 according to any one of the various embodiments of the present invention, whereby treated water 111, from which heavy metal ions such as copper ions have been removed, can be obtained. Thus, treatment of waste water can be carried out so as to meet the actual circumstances of apparatuses, in respective plants, which generate waste water by installing the waste water treatment apparatus of the present invention at the location where the waste water is generated.

When a CMP apparatus and an ECP apparatus coexist, the respective waste water from these apparatus may be treated either separately, or simultaneously as a mixture. When treated water 111 according to the present invention is discharged into a sewage line or supplied to a separate comprehensive waste water treatment facility, an inappropriate water quality, such as pH, if any, should be adjusted in advance.

The ζ potential (zeta potential) of the surface (surface of electric double layer) of solid fine particles such as abrasive particles contained in the copper-containing waste water is either a negative value or a positive value. When the ζ potential of the surface of the solid fine particles is a negative value, no adverse effect on the Cu treatment step occurs. This is because the behavior of the solid fine particles is different from that of copper ions (Cu²⁺) in the electrodialysis operation, and the adsorption of the fine particles on an ion exchanger (cation-exchange nonwoven fabric, cation-exchange resin beads, or cation-exchange membrane) does not occur in the ion exchange operation. On the other hand, when the ζ potential of the surface of the solid fine particles is a positive value, there is a problem that the behavior of the solid fine particles is similar to that of Cu²⁺ to cause the fine particles to be deposited on the surface of the cation-exchange membrane in the electrodialysis operation, or the fine particles are adsorbed together with Cu²⁺ on a cation exchanger such as a cation exchange resin or a cation-exchange nonwoven fabric to cover adsorption sites in the ion exchange operation. Further, there is another problem that these fine particles have poor reactivity with inorganic coagulants such as ferric chloride or PAC which are generally used, and hence formation of coagulated flocs or coagulation of the slurry does not occur in the coagulating sedimentation operation.

Thus, when the ζ potential is a positive value, it is desirable that the waste water is pretreated to convert the ζ potential to a negative value, and is then supplied to the Cu treatment step.

As a means for converting the ζ potential, there may be a method in which a surfactant such as an anionic surfactant or a pH adjusting agent (acid or alkali) is added to the waste water.

When solid fine particles having a positive ζ potential value and solid fine particles having a negative ζ potential value coexist in the copper-containing waste water, the ζ potential value of the whole solid fine particles in the copper-containing waste water is influenced by the magnitude of the ζ potential of the individual solid fine particles and the existing rate of the solid fine particles, and shows either a positive value or a negative value. In this case, even if the ζ potential value of the whole solid fine particles in the copper-containing waste water is a negative value, it is desirable that for the purpose of eliminating the adverse effect of the solid fine particles having a positive ζ potential value, the positive ζ potential value of the solid fine particles is converted to a negative ζ potential value by a ζ potential converting means to further lower the ζ potential value of the whole solid fine particles contained in the copper-containing waste water.

Types of surfactants may include anionic surfactants, cationic surfactants, amphoteric surfactants, and nonionic surfactants. When the surfactant is used for converting the ζ potential from a positive value to a negative value, it is desirable that an anionic surfactant in which the hydrophobic group part becomes anion. Types of anionic surfactants may include carboxylate salt-type surfactants, for example, fatty acid salts, ether carboxylate salts, alkenyl succinates, N-acylamino-acid salts, rhodinic acid salts (resinate), or naphthenic acid salts; sulfuric ester salt-type surfactants, for example, primary alkylsulfuric ester salts, secondary alkylsulfuric ester salts, alkyl ether sulfuric ester salts, alkyl phenyl ether sulfuric ester salts, monoacylglycerine sulfuric ester salts, or sulfated oils/sulfated fatty acid alkyl esters; sulfonate-type surfactants, for example, α-olefin sulfonates, secondary alkyl sulfonates, α-sulfofatty acid ester salts, acyl isethionic acid salts, N-acyl-N-methyltaurine salts, dialkyl sulfosuccinates, alkylbenzenesulfonates, alkylnaphthalenesulfonates, alkyl diphenylether sulfonates, or petroleum sulfonates; and phosphoric ester salt-type surfactants, for example, alkylphosphoric ester salts or alkyl ether phosphoric ester salts.

Examples of such surfactants may include LIPOLAN PB-800 manufactured by Lion Corporation, POLITY N-100K manufactured by Lion Corporation, POLITY PS-1900 manufactured by Lion Corporation, POLITY A-550 manufactured by Lion Corporation, EMULGEN 1118 S-70 manufactured by Kao Corporation, and NEOPELEX manufactured by Kao Corporation.

When the above salt-type anionic surfactants are used, besides cations such as sodium ions or ammonium ions, the addition of such surfactants to the waste water increases cation load on the electrodialysis treatment. Thus, in some cases, there occurs a problem that the Cu separation capability in the electrodialysis treatment is deteriorated. In this case, an H-type surfactant in which a negatively charged hydrophilic group is ionically bonded to a hydrogen ion is used. An example of this type of surfactant is NEOPELEX GS which is manufactured by Kao Corporation and is an unneutralized product before the alkali hydrolysis step in the production process of a surfactant.

Additive rate of the surfactant varies depending upon properties of the solid fine particles such as a concentration of the solid fine particles and ζ potential of the solid fine particles. However, when the concentration of solid fine particles is in the range of 500 to 5000 mg/l and the ζ potential of the whole solid fine particles in the copper-containing waste water is in the range of −50 mV to +50 mV, the additive rate of the surfactant is generally in the range of 10 to 1000 mg/l, preferably in the range of 10 to 500 mg/l. The ζ potential after the addition of the surfactant is generally not more than −20 mV, preferably not more than −30 mV. However, this does not hold true for the case where a nonionic surfactant is used.

The molecular weight of the surfactant which can be used is in the range of 200 to 100000. When foamability after the addition of the surfactant to the waste water is excessively high, it is desirable that a surfactant having a relatively high molecular weight of not less than 10000 is used.

The surfactant as defined in the present invention is not particularly restricted by its name as far as the effect of dispersing the slurry or the effect of lowering the ζ potential can be obtained. Specifically, the surfactant includes materials called dispersants. Further, the surfactant includes organic materials having a sulfo group as a functional group.

When a pH adjusting agent is used, the ζ potential can generally be lowered by increasing the pH with the addition of alkali.

Alkalis which can be used may include potassium hydroxide, sodium hydroxide, ammonia, and amine alkaline agents such as TMAH and choline.

As described above, in a case where copper-containing waste water contains solid fine particles such as abrasive particles, and the ζ potential of the fine particles is a positive value, a ζ potential converting step is provided at the preceding stage of the Cu treatment step. On the other hand, in a case where copper-containing waste water contains solid fine particles, and the ζ potential of the fine particles is a negative value, the waste water is introduced directly into the Cu treatment step. The ζ potential converting step may be provided at any position before the Cu treatment step. Specifically, the ζ potential converting step may be provided before or after the oxidizing agent decomposition step. The surfactant may be added at a position within the CMP apparatus. When the ζ potential converting step is provided, the copper treatment step may be carried out by a combination of electrodialysis operation and electrolytic deposition operation, ion exchange treatment, coagulating sedimentation treatment, or the like.

Next, embodiments in the case where the ζ potential converting step is provided at the preceding stage of the Cu treatment step will be described with reference to FIGS. 23A and 23B.

In the embodiment shown in FIG. 23A, waste water containing Cu and discharged from a CMP step and/or a cleaning step after the CMP step in a semiconductor device fabrication process is supplied to an oxidizing agent decomposition step 2A such as a hydrogen peroxide decomposition step. In the oxidizing agent decomposition step 2A, the oxidizing agent such as hydrogen peroxide or ammonium persulfate contained in the waste water is decomposed, for example, with a platinum-coated catalyst. The waste water discharged from the oxidizing agent decomposition step 2A is supplied to a ζ potential converting step 5. In the ζ potential converting step 5, as described above, a surfactant such as an anionic surfactant or a pH adjusting agent is added to the waste water. The ζ potential of fine particles contained in the waste water is converted to a negative value in the ζ potential converting step 5. The waste water after this converting step is introduced into a copper treatment step 10, and treated in the copper treatment step 10. Thus, treated water having a lowered copper concentration is obtained, and copper is recovered as a copper metal.

The oxidizing agent decomposition step 2A such as a hydrogen peroxide decomposition step and the Cu treatment step 10 are the same as those described in connection with the embodiments shown in FIGS. 1 through 8.

In the embodiment shown in FIG. 23B, waste water containing Cu and discharged from a CMP step and/or a cleaning step after the CMP step in a semiconductor device fabrication process is supplied to a ζ potential converting step 5. In the ζ potential converting step 5, as described above, a surfactant such as an anionic surfactant or a pH adjusting agent is added to the waste water. The ζ potential of fine particles contained in the waste water is converted to a negative value in the ζ potential converting step 5. The waste water after this converting step is supplied to an oxidizing agent decomposition step 2A such as a hydrogen peroxide decomposition step. In the oxidizing agent decomposition step 2A, the oxidizing agent such as hydrogen peroxide contained in the waste water is decomposed by, for example, a platinum-coated catalyst. The waste water discharged from the oxidizing agent decomposition step 2A is introduced into a copper treatment step 10, and treated in the copper treatment step 10. Thus, treated water having a lowered copper concentration is obtained, and copper is recovered as a copper metal.

The oxidizing agent decomposition step 2A such as a hydrogen peroxide decomposition step and the copper treatment step 10 are the same as those described in connection with the embodiments shown in FIGS. 1 through 8.

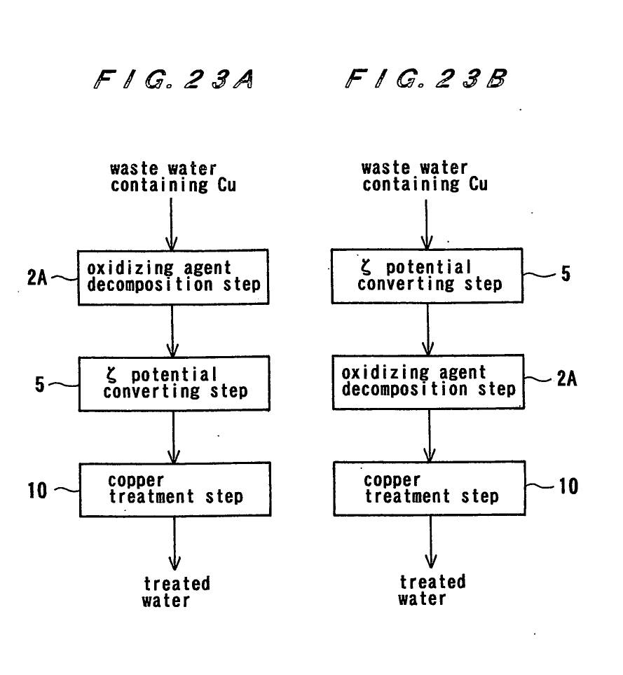

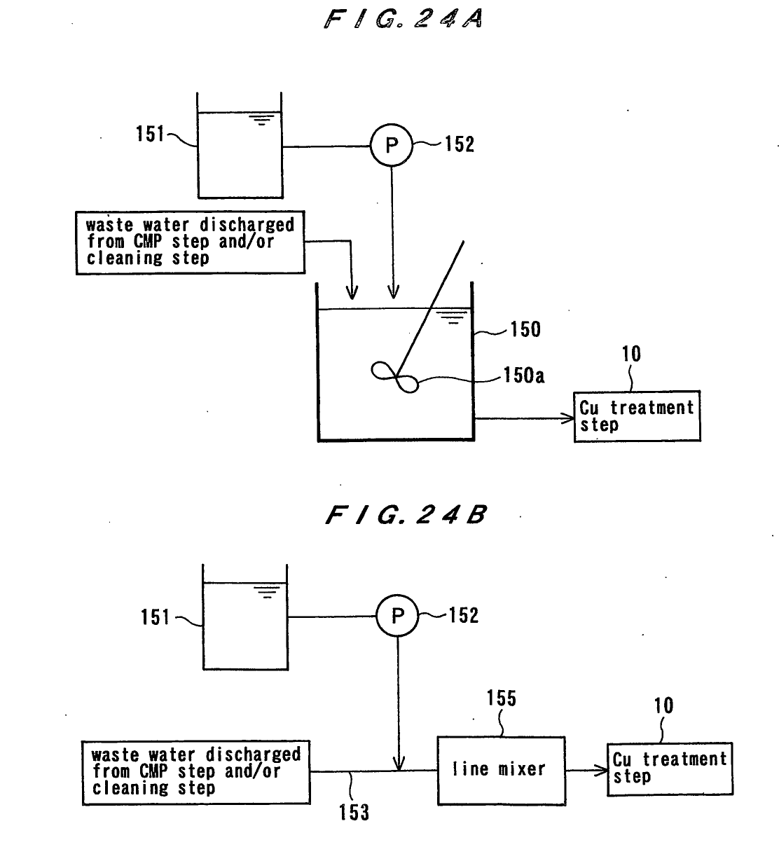

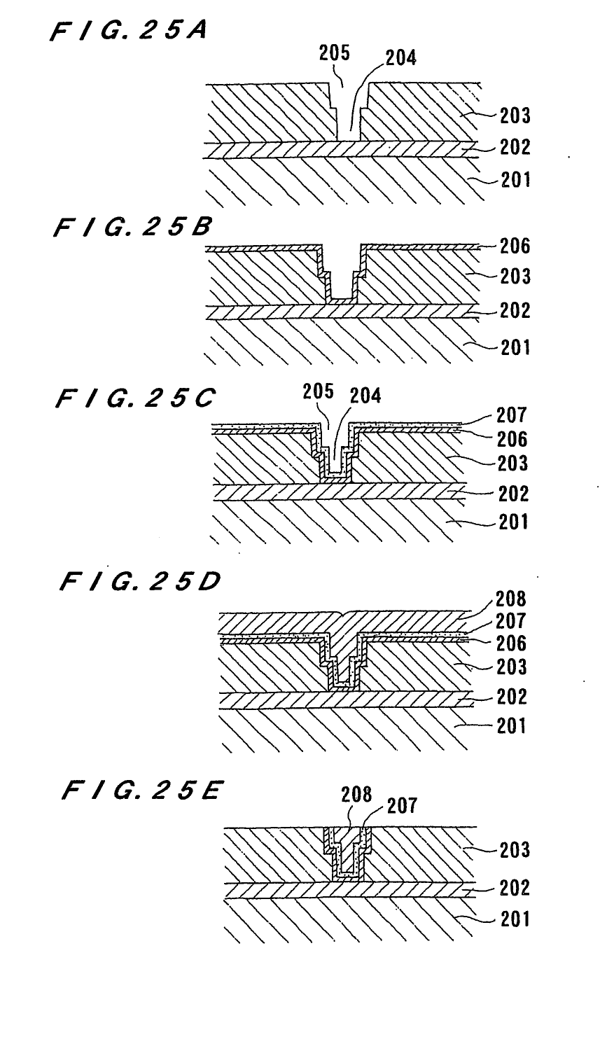

FIGS. 24A and 24B are schematic views showing the construction of a ζ potential converting apparatus for carrying out the above-described ζ potential converting step. As shown in FIG. 24A, the ζ potential converting apparatus comprises an stirring tank 150, a chemical liquid storage tank 151 for storing a chemical liquid such as a surfactant, and a pump 152 for supplying the chemical liquid stored in the chemical liquid storage tank 151 to the stirring tank 150. The waste water containing copper and discharged from the CMP step and/or the cleaning step is supplied to the stirring tank 150. Further, the chemical liquid is supplied from the chemical liquid storage tank 151 to the stirring tank 150. The waste water and the chemical liquid supplied to the stirring tank 150 are stirred by means of an stirring device 150a, and are then transferred to the copper treatment step 10. Alternatively, as shown in FIG. 24B, the ζ potential converting apparatus may be constructed such that the chemical liquid is supplied from the chemical liquid storage tank 151 directly to a waste water line 153 through the pump 152, and waste water containing copper and discharged from the CMP step and/or the cleaning step and the chemical liquid are mixed with each other in a line mixer 155 provided in the line 153.

The copper treatment step shown in FIGS. 23A and 23B may be performed by ion exchange treatment or coagulating sedimentation treatment which will be described below.

Next, ion exchange treatment will be described below. In FIGS. 23A and 23B, waste water which has been subjected to the ζ potential converting step or the oxidizing agent decomposition step is subjected to ion exchange treatment which uses an ion exchanger. An ion exchanger comprises a column having bead-like ion exchange resin filled therein, a fabric material such as woven fabric or nonwoven fabric, a porous film, a spacer having diagonal meshes, or the like. Waste water (water to be treated) containing metal ions is passed through a liquid filter apparatus having a water-permeable sheet formed by the ion exchanger. Metal ions M⁺ in the waste water are adsorbed by the ion exchanger with ion exchange. Thus, the metal ions M⁺ contained in the waste water are removed and recovered more reliably. In the ion exchange process, the waste water may be passed through layers of the ion exchanger. Alternatively, the waste water may be passed along surfaces of layers of the ion exchanger.

Any ion exchange resin beads known in the art may be used for this purpose. For example, strongly acidic cation-exchange resin beads which are used in the present invention can be obtained by using the beads as a basic resin comprising polystyrene which is crosslinked with divinylbenzene, and sulfonating the beads by a sulfonating agent such as sulfuric acid or chlorosulfonic acid to introduce sulfonic group into the basic resin. This production method is known in the art and a variety of products produced by this method are now commercially available. It is also possible to use the resin beads which have various functional groups, for example, functional groups derived from iminodiacetic acid and its sodium salt, functional groups derived from various amino acids such as phenylalanine, lysine, leucine, valine, proline and their sodium salts, and functional groups derived from iminodiethanol.

As an ion-exchange fibrous material which can be used for the same purpose, it is preferable to use a fibrous material comprising polymer fibers as substrates to which ion-exchange groups are introduced by graft polymerization. The substrates of polymer fibers to be grafted may either be single fibers of a polyolefine such as polyethylene or polypropylene, or composite fibers comprising a core portion and a sheath portion in which the core portion and the sheath portion are made of different polymers respectively. Example of composite fibers which can be used in the present invention is composite fibers having a core-sheath structure in which a polyolefin such as polyethylene constitutes the sheath and other polymer such as polypropylene which is not used for the sheath constitutes the core. The ion-exchange fibrous materials, which are obtained by introducing ion-exchange groups into the composite fibers by a radiation-induced graft polymerization, are excellent in the ion-exchangeability and can be produced with a uniform thickness, and therefore are desirable as ion-exchange fibrous materials to be used for the above object. The ion-exchange fibrous material may be in the form of a woven fabric, nonwoven fabric, and the like.

As an ion exchanger in the form a spacer member such as a diagonal net, an ion exchanger comprising a polyolefin resin is preferably used for its excellent ion exchange ability and excellent ability to disperse the water to be treated. For example, a polyethylene diagonal net which is widely employed in electrodialysis baths is used as substrates and ion-exchange ability is imparted by utilizing a radiation-induced graft polymerization, then desirable ion exchanger is obtained.

The radiation-induced graft polymerization is a technique for introducing a monomer into polymer substrates by irradiating the polymer with radiation rays so as to produce a radical which reacts with the monomer.

Radiation rays usable for the radiation-induced graft polymerization include α-rays, β-rays, γ-rays, electron beam, ultraviolet rays, and the like. Of these, γ-rays or electron beam may preferably be used in the present invention. As the radiation-induced graft polymerization, there are a pre-irradiation graft polymerization comprising previously irradiating graft substrates with radiation rays and then contacting the substrates with a grafting monomer, and a co-irradiation method in which irradiation of radiation rays is carried out in the co-presence of substrates and a grafting monomer. Both of these methods may be employed in the present invention. Further, depending upon the manner of contact between a monomer and substrates, there are polymerization methods such as a liquid-phase graft polymerization method in which polymerization is effected while substrates are immersed in a monomer solution, a gas-phase graft polymerization method in which polymerization is effected while substrates are in contact with vapor of monomer, and an immersion gas-phase graft polymerization method in which substrates are firstly immersed in a monomer solution and then taken out of the monomer solution and a polymerization is effected in a gas phase. Either method of polymerization may be employed in the present invention.

The ion-exchange groups to be introduced into fibrous substrates such as a nonwoven fabric, or into spacer substrates are not particularly limited. Various kinds of cation-exchange groups and anion-exchange groups can be used. For instance, usable cation-exchange groups include strongly acidic cation-exchange groups such as sulfo group, moderately acidic cation-exchange groups such as phosphoric group, and weakly acidic cation-exchange groups such as carboxy group. Usable anion-exchange groups include weakly basic anion-exchange groups such as primary, secondary and tertially amino groups, and strongly basic anion-exchange groups such as quaternary ammonium group. Further, an ion exchanger having both of the above-described cation and anion groups may also be employed. Furthermore, it is also possible to use an ion exchanger having functional groups such as functional groups derived from iminodiacetic acid or its sodium salt, functional groups derived from various amino acids including phenylalanine, lysine, leucine, valine, proline or their sodium salts or functional groups derived from iminodiethanol.

These various ion-exchange groups can be introduced into fibrous substrates or spacer substrates by subjecting a monomer having such an ion-exchange group to graft polymerization, preferably radiation-induced graft polymerization, or by subjecting a polymerizable monomer having a group that are changeable into an ion-exchange group, to graft polymerization, followed by conversion of that group into the ion-exchange group. Monomers having an ion-exchange group usable for this purpose may include acrylic acid (AAc), methacrylic acid, sodium styrenesulfonate (SSS), sodium methallylsulfonate, sodium allylsulfonate, sodium vinylsulfonate, vinylbenzyl trimethylammonium chloride (VBTAC), diethylaminoethyl methacrylate, and dimethylaminopropylacrylamide. Sulfo group as a strongly acidic cation-exchange group, for example, may be introduced directly into substrates by carrying out radiation-induced graft polymerization in which sodium styrenesulfonate is used as a monomer. Quaternary ammonium group as a strongly basic anion-exchange group may be introduced directly into substrates by carrying out radiation-induced graft polymerization in which vinylbenzyl trimethylammonium chloride is used as a monomer.

The monomer having groups that can be converted into ion-exchange groups may include acrylonitrile, acrolein, vinylpyridine, styrene, chloromethylstyrene, and glycidyl methacrylate (GMA). Sulfo group as a strongly acidic cation-exchange group, for example, may be introduced into substrates in such a manner that glycidyl methacrylate is introduced into the substrates by radiation-induced graft polymerization, and then react with a sulfonating agent such as sodium sulfite. Quaternary ammonium group as a strongly basic anion-exchange group may be introduced into substrates in such a manner that chloromethylstyrene is graft-polymerized onto substrates and then the substrates are immersed into an aqueous solution of trimethylamine to effect quaternary-ammonification. Further, sodium iminodiacetate group as a functional group can be introduced into substrates in such a manner that chloromethylstyrene is graft-polymerized onto substrates and the substrates react with a sulfide to make a sulfonium salt, and then the sulfonium salt reacts with sodium iminodiacetate. Alternatively, sodium iminodiacetate as a functional group may be introduced into substrates in such a manner that chloromethylstyrene is graft-polymerized onto substrates and chloro group is substituted with iodine group and iodine group reacts with an iminodiacetic acid diethyl ester to substitute iodine group with an iminodiacetic acid diethyl ester group, and finally the ester group reacts with sodium hydroxide to convert the ester group into sodium salt.

Among the above-described various forms of ion exchangers, an ion-exchange fibrous material in the form of a nonwoven fabric or a woven fabric is particularly preferable. A fibrous material, such as a woven fabric or a nonwoven fabric, as compared to materials in the form of beads, a diagonal net, and the like has a remarkably larger surface area, and therefore a larger amount of ion exchange groups can be introduced thereinto. Further, unlike the case of resin beads in which ion-exchange groups are present in micropores or macropores within the beads, all the ion-exchange groups are present on the surfaces of fibers in the case of an ion-exchange fibrous material. Accordingly, metal ions in the water to be treated can easily diffuse into the vicinity of ion-exchange groups, and the ions are adsorbed by means of ion exchange. Therefore, the use of an ion-exchange fibrous material can thus improve removal and recovery efficiency of metal ions.

Next, a coagulating sedimentation treatment will be described below.

In FIGS. 23A and 23B, waste water which has been subjected to the ζ potential converting step 5 or the oxidizing agent decomposition step 2A is received by a coagulating sedimentation tank. In the coagulating sedimentation tank, a coagulant is added to the water to be treated, whereby metal ions in the water to be treated are coagulated and precipitated, and removed from the water, while the supernatant liquid is recovered as treated water. The metal precipitated in the coagulating sedimentation is recovered as a precipitate and, if necessary, subjected to a subsequent treatment. As the coagulant to be used in such a system for coagulating sedimentation metal ions in water to be treated, various chemicals known in the art as usable for coagulating and precipitating metal ions in an aqueous medium, can be used. Specific examples include an alkali such as NaOH, Ca(OH)₂ or KOH, a polymer coagulant, inorganic coagulant such as FeSO₄ and FeCl₃. When inorganic coagulant containing Fe²⁺ such as FeSO₄ is used, since Fenton reaction occurs, hydrogen peroxide and chelating agent are decomposed. Thus, using FeSO₄ is more preferable. A sludge produced by the coagulating treatment may be filtered through a membrane, such as an MF membrane which is generally used in waste water treatment.

### EXAMPLES

Specific examples according to the present invention will be described below. The present invention is not limited to the following examples.

### Example 1

<Productions of Cation-Exchange Nonwoven Fabric>

In this example, nonwoven fabric having the following characteristics was used as a base material for producing a cation-exchange nonwoven fabric. The base nonwoven fabric was formed by thermal fusion of composite fiber which consists of a core portion of polypropylene and a sheath portion of polyethylene.

TABLE 1

| Component of core | Polypropylene |
|---|---|
| Component of sheath | Polyethylene |
| Areal density | 50 g/m² |
| Thickness | 0.55 mm |
| Diameter of fiber | 15-40 μm |
| Producing method of nonwoven fabric | thermal fusion |
| Porosity | 91% |

A gamma ray was irradiated to the nonwoven fabric substrates under a nitrogen atmosphere and then immersed into a solution of glycidyl methacrylate (GMA). Thus, the nonwoven fabric substrates were reacted with the solution to form graft-polymerized nonwoven fabric having a graft ratio of 175%. The graft-polymerized nonwoven fabric was immersed into a mixed solution of sodium sulfite, isopropyl alcohol, and water, for sulfonation. Thus, a cation-exchange nonwoven fabric was produced. When the ion exchange capacity of the cation-exchange nonwoven fabric was measured, it was found that a strongly acidic cation-exchange nonwoven fabric having a salt splitting capacity of 2.82 meq/g was obtained.

### Example 2

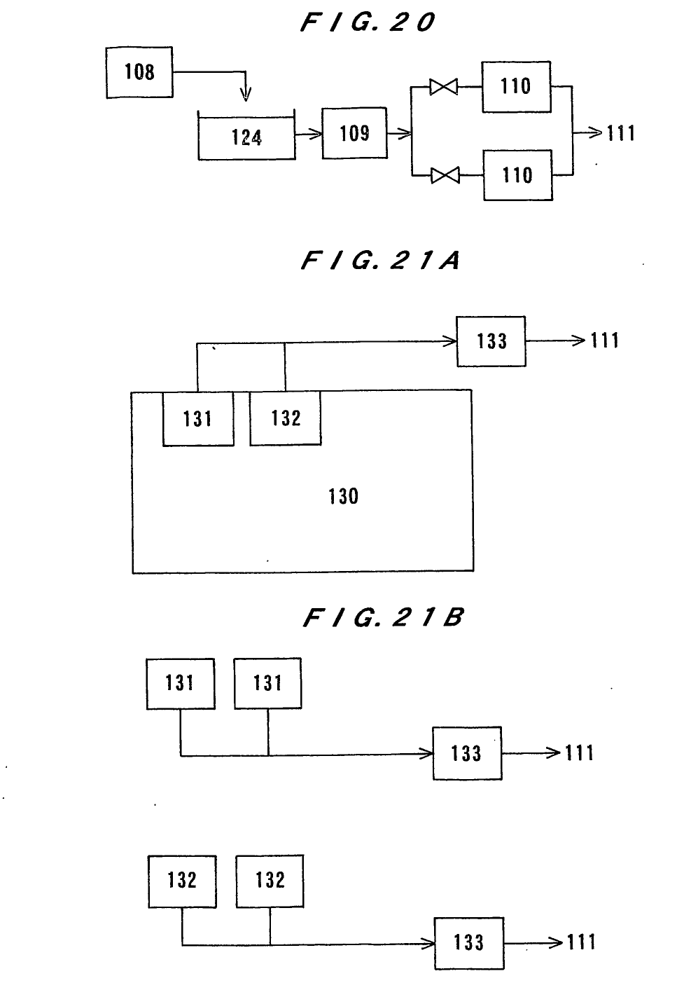

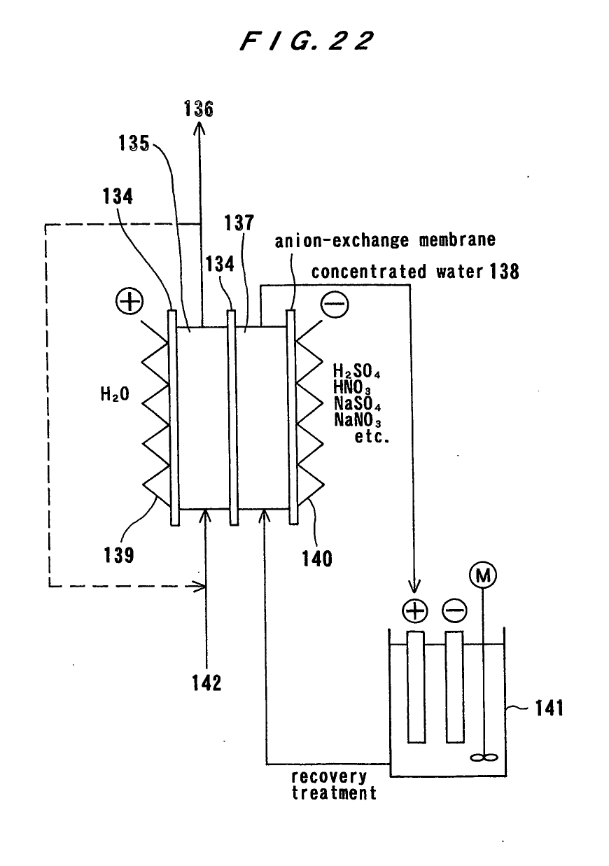

Experiment was carried out using the experimental apparatus shown in FIG. 22. In FIG. 22, the reference numeral 134 denotes a cation-exchange membrane, 136 denotes treated water, 138 denotes concentrated water, 141 denotes an electrolytic deposition apparatus, and 142 denotes water to be treated. In the separation treatment, the cation-exchange nonwoven fabric having sulfo group was used as an ion exchanger in the desalting chamber 135, and the cation-exchange nonwoven fabric having sulfo group was used as an ion exchanger in the concentrating chamber 137. As electrode material, the cathode 140 was made of expanded metal (material: SUS), and the anode 139 was made of expanded metal (material: titanium coated with platinum). Sulfuric acid was supplied to the cathode chamber so that a pH of the liquid became 1.5 or less.

In the recovery of copper, plate-like electrodes were employed. The anode material was titanium coated with platinum, and the cathode material was copper. The bath was stirred at a rotational speed of 300 rpm (m⁻¹) by means of a stirrer.

Experiment I was carried out using a copper-plating rinsing waste water as raw water. Experiment II was carried out using CMP waste water discharged from a polishing process for polishing copper as raw water. The CMP waste water was treated using a platinum-coated metal honeycomb catalyst so that the remaining H₂O₂ was reduced to not more than 1 mg/l. The slurry concentration of the CMP waste water was 2000 ppm in terms of TS (Total Solid: Residue, Total, EPA Method 160.3).

The current density was set at 3 A(ampere)/dm² both in the separation treatment and the recovery treatment.

As a result, in Experiment I, the Cu concentration of raw water was 120 ppm, whereas the Cu concentration of treated water was less than 0.1 ppm. The constitution of this Example could also attain the effect of the present invention. The copper ion concentration concentrated in the concentrating chamber was found to be not less than 1000 ppm. The copper ions in the concentrated water were recovered as copper metal at the cathode in the recovery treatment step.

In Experiment II, the Cu concentration of raw water was 110 ppm, whereas the Cu concentration of treated water was less than 0.1 ppm. The copper ions in the concentrated water were recovered as copper metal at the cathode in the recovery treatment step. It was thus confirmed that an influence of slurry was not recognized in a long-sustained operation and the effect of the present invention could be attained also for the CMP waste water.

### Example 3

<Hydrogen Peroxide Decomposition Treatment>

Slurry-suspended Cu-CMP waste water (TS: 2500 mg/l, Cu concentration: 100 mg/l, H₂O₂ concentration: 1000 mg/l, ζ potential of slurry: minus (negative) value (−20 mV or less) in a pH of 3 to 10 although the ζ potential varies depending upon pH) was adjusted to a pH of 5 by the addition of sulfuric acid, and then hydrogen peroxide in the waste water is decomposed in a hydrogen peroxide decomposition apparatus shown in FIG. 3. A catalyst-packed tower having a three-column structure was used. A gas-liquid separator was provided between adjacent columns to remove an oxygen gas generated by the decomposition of hydrogen peroxide.

The treatment was carried out under conditions of water flowing speed 30 m/hour and contact time 3 minutes (in total of three columns). The catalyst used was a platinum-coated metal honeycomb catalyst (having an acid-resistant coating), and had a pore density of 500 cell/square inch. The amount of platinum coated by the metal honeycomb catalyst was 2 g/l. As a result, the concentration of hydrogen peroxide in the raw water was reduced to less than 5 mg/l by the decomposition.

This performance of hydrogen peroxide decomposition was also achieved when the Cu-CMP waste water whose pH had not been adjusted was used as waste water to be treated. Further, in the case of waste water discharged from a Cu plating process and having a hydrogen peroxide concentration of 3000 mg/l and a Cu concentration of 100 mg/l, the concentration of hydrogen peroxide in the waste water was reduced to less than 5 mg/l by the decomposition under the same treatment conditions as the above.

<CMP Slurry Separation Test>

Treated water obtained by the hydrogen peroxide decomposition treatment (Cu-CMP waste water, pH unadjusted) was used for a slurry separation test. 50 mg/l of ferric chloride was added to and mixed with the treated water, and a mixed liquid was treated so that its pH was adjusted to 5 by the addition of KOH. As a result, the mixed liquid containing coagulated flocs (SS 2200 mg/l) was obtained. This mixed liquid was allowed to stand for 30 minutes, thus obtaining a clear supernatant liquid containing no slurry. The clear supernatant liquid containing no slurry was also obtained after 3 mg/l of anionic polymer coagulant was added to the mixed liquid and then the mixed liquid was allowed to stand. The use of the anionic polymer coagulant increased the sedimentation speed of the slurry-containing coagulated floc, and its sedimentation speed was not less than 100 mm/minute (SS concentration after solid-liquid separation <10000 mg/l). The concentration of Cu in the supernatant liquid was 90 mg/l, and it was confirmed that most of copper in the raw water remained in the supernatant liquid.

This supernatant liquid was filtered by an organic membrane filter having a pore diameter of 1.0 μm, thus obtaining water from which slurry was separated. Further, even in using a ceramic filter having a pore diameter of 0.1 μm, it was confirmed that the supernatant liquid could be successfully filtered to give a filtrate.

<Cu Treatment Test>

Treated water obtained by the hydrogen peroxide decomposition treatment (Cu-CMP waste water; adjusted to a pH of 5; containing slurry) was used for a Cu treatment test. In the test, a Cu treatment apparatus having a construction shown in FIG. 5 was used.

The first desalting chamber and the second desalting chamber were packed with a cation-exchange nonwoven fabric. The cation-exchange nonwoven fabric was produced by introducing styrene into a substrate nonwoven fabric (tradename: T6, manufactured by Japan Vilene Co., Ltd., core and sheath component: PE) by graft polymerization (graft ratio 107%) and sulfonating the graft-polymerized nonwoven fabric to provide an ion exchange capacity of 650 to 700 meq/m². The cation-exchange nonwoven fabric produced by the graft polymerization, a cation-exchange spacer, and an anion-exchange nonwoven fabric were packed in the concentrating chamber.

The separation step was carried out under the following conditions: Water flowing conditions: SV 120 [h⁻¹] (total of first desalting chamber and second desalting chamber), energization conditions: constant-current operation (3 A/dm²), LV=60 m/hour.

The Cu recovery step was carried out under conditions of constant-potential operation (cathode potential −0.1 V), cathode: Cu plate (2 dm²), and anode Ti/Pt lath plate (2 dm²).

The acid recovery step was carried out under the following conditions: Water flowing conditions: SV 60 [h⁻¹], energization conditions: constant-current operation (2 to 3 A/dm²), LV=60 m/hour. The pH of both CuSO₄ circulation water and H₂SO₄ circulation water was 1.5.

As a result, the concentration of Cu in the treated water was 0.050 mg/l. No adverse effect of the slurry on the treatment capability was observed. Further, it was also confirmed that Cu recovered as CuSO₄ concentrated water was recovered as a Cu metal on the cathode surface in the Cu recovery step. It was also confirmed that the pH of both CuSO₄ circulation water and H₂SO₄ circulation water was maintained in the range of 1.4 to 1.6 during operation.

Similary, even when the slurry-separated water after the CMP slurry separation test or treated water obtained by hydrogen peroxide decomposition treatment of the waste water discharged from the Cu plating step was used as the test water, it was confirmed that the concentration of Cu in the treated water was less than 0.1 mg/l.

### Example 4

Copper-containing waste water discharged from a Cu-CMP apparatus and containing 2000 ppm of CMP abrasive particles with a positive value of ζ potential (ζ potential: 13 mV, cumulant average particle diameter (hydrodynamic equivalent diameter): 800 nm, composition: a mixture of SiO₂ and Al₂O₃) and 100 ppm of copper ions was treated with a platinum-coated metal honeycomb catalyst shown in FIG. 3 to reduce the amount of residual H₂O₂ to less than 1 mg/l, and the treated water was then supplied to a Cu treatment apparatus shown in FIG. 6. The Cu treatment apparatus was operated under the following conditions:

Current density: 3 A/dm²

SV: 100 l/hour

As a result, the operating voltage was 20 V in an initial stage of the operation. The operating voltage, however, rose with the elapse of time. After an elapse of 30 minutes from the start of the operation, the operating voltage reached 40 V. The operation was stopped, and the interior of the apparatus for the separation step was inspected. Then, it was found that CMP abrasive particles were deposited on the surface of the ion-exchange membrane on the cathode side of the desalting chamber. Further, it was confirmed that gelled CMP abrasive particles were deposited on the surface of the cation-exchange nonwoven fabric packed into the desalting chamber.

### Example 5

Copper-containing waste water containing 2000 ppm of CMP abrasive particles with a negative value of ζ potential (ζ potential: −25 mV, hydrodynamic equivalent diameter: 600 nm, composition: a mixture of SiO₂ and Al₂O₃) and 50 ppm of copper ions was treated with a platinum-coated metal honeycomb catalyst shown in FIG. 3 to reduce the amount of residual H₂O₂ to less than 1 mg/l, and the treated water was then supplied to a Cu treatment apparatus shown in FIG. 6.

The operation was carried out under the same conditions as those in Example 1. As a result, the operating voltage was in the range of 20 to 25 V, and the stable operation could be carried out for 24 hours or longer. After the operation was carried out for 24 hours, the interior of the apparatus for the separation step was inspected. Then, the deposition of the abrasive particles and the gelation of the abrasive particles within the desalting chamber were not observed at all. The concentration of Cu in the treated water was less than 0.5 mg/l.

### Example 6

The copper-containing waste water used in Example 4 was treated with a platinum-coated catalyst (metal honeycomb catalyst) shown in FIG. 3 to reduce the amount of residual H₂O₂ to less than 1 mg/l, and 0.5% of chemical stock solution containing an anionic surfactant was then added to the treated water. As a result, the ζ potential was −15 mV. Water flowing was carried out using the same. Cu treatment apparatus as that in Example 4 under the same operating conditions as those in Example 4. As a result, the operating voltage was in the range of 20 to 25 V, and the stable operation could be carried out for 24 hours or longer. During the operation, the deposition of the abrasive particles and gelation of the abrasive particles within the desalting chamber were not observed.

### Example 7

The copper-containing waste water used in Example 4 was treated with a platinum-coated catalyst (metal honeycomb catalyst) shown in FIG. 3 to reduce the amount of residual H₂O₂ to less than 1 mg/l, and chemical stock solution containing an anionic surfactant different from that of Example 6 was then added to the treated water. By the additive rate of 1.2%, the ζ potential was lowered to −18 mV. Water flowing was carried out using the same Cu treatment apparatus as that in Example 4 under the same operating conditions as those in Example 4. As a result, the operating voltage was in the range of 20 to 25 V, and the stable operation could be carried out for 24 hours or longer. During the operation, the deposition of the abrasive particles and gelation of the abrasive particles within the desalting chamber were not observed. The concentration of Cu in the treated water was less than 0.5 mg/l.

### Example 8

Copper-containing waste water discharged from a Cu-CMP apparatus and containing 2000 ppm of CMP abrasive particles with a positive value of ζ potential (ζ potential: 13 mV, cumulant average particle diameter (hydrodynamic equivalent diameter): 800 nm, composition: a mixture of SiO₂ and Al₂O₃) and 100 ppm of copper ions was treated with a platinum-coated metal honeycomb catalyst shown in FIG. 3 to reduce the amount of residual H₂O₂ to less than 1 mg/l, and the treated water was then supplied to an ion exchange resin column packed with strongly acidic cation-exchange resin beads.

Water flowing was carried out at LV 30 m/hour. As a result, the quality of the treated water was as follows: Cu: less than 0.5 mg/l at an initial stage of the operation, the Cu treatment capability reduced with the elapse of time, after an elapse of 12 hours from the start of the operation, the concentration of Cu in the treated water increased to 3 mg/l. On the other hand, 0.5% of chemical stock solution containing an anionic surfactant was added to the waste water which had been subjected to H₂O₂ decomposition treatment in the same manner as Example 6, and then the waste water was supplied to the ion-exchange resin column packed with the strongly acidic cation-exchange resin beads in the same manner as the above. Then, the quality of the treated water was as follows: Cu: less than 0.5 mg/l even after an elapse of 24 hours from the start of water flowing.

### Example 9

Copper-containing waste water discharged from a Cu-CMP apparatus and containing 2000 ppm of CMP abrasive particles with a positive value of ζ potential (ζ potential: 13 mV, cumulant average particle diameter (hydrodynamic equivalent diameter): 800 nm, composition: a mixture of SiO₂ and Al₂O₃) and 100 ppm of copper ions was treated with a platinum-coated metal honeycomb catalyst shown in FIG. 3 to reduce the amount of residual H₂O₂ to less than 1 mg/l, and coagulating separation treatment was then carried out using ferric chloride as an inorganic coagulant. In this case, the amount of the ferric chloride added was 50 mg-Fe/l, and the pH of the waste water for coagulation was 5. As a result, the presence of a coagulated floc was not observed at all, and hence the abrasive particles could not be separated from the waste water. On the other hand, 0.5% of chemical stock solution containing an anionic surfactant was added to the waste water which had been subjected to H₂O₂ decomposition treatment in the same manner as Example 6, and then the waste water was subjected to coagulating separation in the same manner as the above. Thus, coagulated flocs were formed and the abrasive particles could be separated. Further, the pH of the waste water at the time of forming coagulated flocs was increased to 7, and the concentration of Cu in the filtrate (pore diameter of filter paper: 1.0 μm) of the supernatant liquid was measured. Then, it was confirmed that the concentration of Cu was reduced to less than 0.5 mg/l.

### Example 10

Hydrogen peroxide contained in slurry-suspended Cu-CMP waste water (pH: 5, TS (Total Solid) : 2500 mg/l, TSS (Total Solid Soluble): 500 mg/l, Cu concentration: 100 mg/l, H₂O₂ concentration: 1200 mg/l, composition of slurry: a mixture of silica and alumina, ζ potential of slurry: −20 mV), was decomposed in a hydrogen peroxide decomposition apparatus shown in FIG. 3. A catalyst-packed tower was composed of a three-column structure, and a gas-liquid separator was provided between adjacent columns to remove an oxygen gas generated by the decomposition of hydrogen peroxide. The catalyst used was a platinum-coated metal honeycomb catalyst (having an acid-resistant coating) and had a pore density of 500 cell/square inch. The amount of platinum coated by the metal honeycomb catalyst was 2 g/l.

The treatment was carried out under conditions of water flowing speed 30 m/hour and contact time 3 minutes (in total of three columns). As a result, the concentration of hydrogen peroxide in the raw water was reduced to less than 5 mg/l by the decomposition.

After the hydrogen peroxide decomposition treatment, the Cu-CMP waste water was adjusted to a pH of 3 by the addition of sulfuric acid., In this state, the ζ potential of the slurry was measured and found to be −15 mV. Next, 300 mg/l of an anionic surfactant having sulfo group (POLITY PS-1900, manufactured by Lion Corporation) was added to the waste water, and the ζ potential of the slurry was measured and found to be reduced to −25 mV.

The Cu-CMP waste water after the addition of the surfactant was used as raw water and was subjected to a treatment test with a Cu treatment apparatus shown in FIG. 6. The treatment was carried out under the following conditions: The treatment operation was continued for 5 days. Then, the operating voltage was stable at a voltage of 25 V, and the quality of the treated water was in the range of 0.1 to 0. 3 mg-Cu/l. The concentration of Cu in the CuSO₄ concentrated water was in the range of 80 to 120 mg/l. After the operation of the apparatus, the electrodialysis apparatus in the separation step was dismantled, and the interiors of the first desalting chamber and the second desalting chamber were inspected. As a result, it was confirmed that there was no coagulation of the slurry at all. Separately, a five-day treatment experiment was carried out as a comparative experiment in which no surfactant was added to the Cu-CMP waste water. In the comparative experiment, the experimental apparatus and conditions used were the same as those in the above. As a result, the operating voltage rose from 25 V to 35 V, and after the operation of the apparatus, coagulation of the slurry was observed within the first desalting chamber and the second desalting chamber. Thus, it was confirmed that the addition of the surfactant had the effect of stabilizing the treatment operation.

1) Separation step
Water flowing speed
   (a) Water to be treated: SV: 50 [l/hr] (total of first desalting chamber and second desalting chamber)
   (b) CuSO₄ concentrated water: SV 100 [l/hr]
   (c) H₂SO₄ aqueous solution: SV 100 [l/hr]
Current density 2 A (ampere)/dm²

2) Acid recovery step
Water flowing speed
   (a) CuSO₄ concentrated water: SV 100 [l/hr]
   (b) H₂SO₄ aqueous solution: SV 100 [l/hr]
Current density 2 A (ampere)/dm²

3) Cu (copper) recovery step
Energization method: constant-potential operation (cathode potential −0.1 V)
Electrode
   (a) Cathode: Cu plate (2 dm²)
   (b) Anode: Ti/Pt lath plate (2 dm²)

4) pH of circulating water
CuSO₄ concentrated water: 1.5
H₂SO₄: 1.5

5) Materials used (separation step and acid recovery step)
Positive electrode: Ti/Pt lath-type electrode
Negative electrode: SUS 304 lath-type electrode
Cation-exchange membrane: CMB manufactured by TOKUYAMA Corp.
Anion exchange membrane: AHA manufactured by TOKUYAMA Corp.
Cation-exchange nonwoven fabric
   (a) First desalting chamber and second desalting chamber: produced by radiation-induced graft polymerization. Substrate nonwoven fabric material: PE, functional group: sulfo group
   (b) Places other than first desalting chamber and second desalting chamber: produced by radiation-induced graft polymerization. Substrate nonwoven fabric material: PP/PE, functional group: sulfo group
Anion-exchange nonwoven fabric: produced by radiation-induced graft polymerization. Substrate nonwoven fabric material: PP/PE, functional group: quaternary ammonium group
Cation exchange spacer: produced by radiation-induced graft polymerization. Substrate spacer: PE, functional group: acrylic acid and sulfonic acid
Anion exchange spacer: produced by radiation-induced graft polymerization. Substrate spacer: PE, functional group: quaternary ammonium group

### EXAMPLE 11

The Cu-CMP waste water, which had been subjected to the hydrogen peroxide decomposition treatment, prepared in Example 10 was adjusted to a pH of 3 by the addition of sulfuric acid and NEOPELEX GS manufactured by Kao Corporation as H-type anionic surfactant having sulfo group. Additive rate of the H-type anionic surfactant was 300 mg/l. In this state, the ζ potential of the slurry was measured and found to be −30 mV. This value was lower than a ζ potential −15 mV in a case where only sulfuric acid was used for the pH adjustment.

The Cu-CMP waste water after the addition of the surfactant was used as raw water and was subjected to a treatment test with a Cu treatment apparatus shown in FIG. 6. The treatment was carried out under the same conditions as those in Example 10. The treatment operation was continued for 5 days. Then, the operating voltage was stable at a voltage of 25 V, and the quality of the treated water was less than 0.1 mg-Cu/l during the treatment operation. The quality of the treated water was lower than that in Example 10. After the operation of the apparatus, the electrodialysis apparatus in the separation step was dismantled, and the interiors of the first desalting chamber and the second desalting chamber were inspected. As a result, it was confirmed that there was no coagulation of the slurry at all. Thus, it was confirmed that the utilization of the H-type anionic surfactant further enhanced Cu treatment performance.

### Example 12

The Cu-CMP waste water, which had been subjected to the hydrogen peroxide decomposition treatment, prepared in Example 10 was adjusted to a pH of 3 by the addition of sulfuric acid and NEOPELEX GS manufactured by Kao Corporation as H-type anionic surfactant having sulfo group. Additive rate of the H-type anionic surfactant was 300 mg/l. In this state, the ζ potential of the slurry was measured and found to be −30 mV. This value was lower than a ζ potential −15 mV in a case where only sulfuric acid was used for the pH adjustment.

The Cu-CMP waste water after the addition of the surfactant was used as raw water and was subjected to a treatment test with a Cu treatment apparatus shown in FIG. 26. The treatment was carried out under the following conditions: The treatment operation was continued for 5 days. Then, the operating voltage was stable at a voltage of 25 V, and the concentration of Cu in the treated water was less than 0. 1 mg-Cu/l during the treatment operation. The quality of the treated water was lower than that in Example 10. After the operation of the apparatus, the electrodialysis apparatus in the separation step was dismantled, and the interiors of the first desalting chamber and the second desalting chamber were inspected. As a result, it was confirmed that there was no coagulation of the slurry at all. Thus, it was confirmed that the use of an integral electrodialysis apparatus shown in FIG. 26, which performs both the separation step and the acid recovery step, was also effective.

1) Electrodialysis apparatus (which performed both separation step and acid recovery step)
Water flowing speed
   (a) Water to be treated: SV: 50 [l/hr] (total of first desalting chamber and second desalting chamber)
   (b) CuSO₄concentrated water: SV100 [l/hr] (for each of acid recovery chamber and concentrating chamber)
   (c) H₂SO₄ aqueous solution: SV 100 [l/hr]
Current density 2 A (ampere)/dm²

2) Cu (copper) recovery step
Energization method: constant-potential operation (cathode potential −0.1 V)
Electrode
   (a) Cathode: Cu plate (2 dm²)
   (b) Anode: Ti/Pt lath plate (2 dm²)

3) pH of circulating water
CuSO₄ concentrated water: 1.5
H₂SO₄: 1.5

4) Materials used (electrodialysis apparatus)
Positive electrode: Ti/Pt lath-type electrode
Negative electrode: SUS 304 lath-type electrode
Cation exchange membrane: CMB manufactured by TOKUYAMA Corp.
Anion exchange membrane: AHA manufactured by TOKUYAMA Corp.
Cation-exchange nonwoven fabric
   (a) First desalting chamber and second desalting chamber: produced by radiation-induced graft polymerization. Substrate nonwoven fabric material: PE, functional group: sulfo group
   (b) Places other than first desalting chamber and second desalting chamber: produced by radiation-induced graft polymerization. Substrate nonwoven fabric material: PP/PE, functional group: sulfo group
Anion-exchange nonwoven fabric: produced by radiation-induced graft polymerization. Substrate nonwoven fabric material: PP/PE, functional group: quaternary ammonium group
Cation exchange spacer: produced by radiation-induced graft polymerization. Substrate spacer: PE, functional group: acrylic acid and sulfonic acid
Anion exchange spacer: produced by radiation-induced graft polymerization. Substrate spacer: PE, functional group: quaternary ammonium group

### Example 13

The Cu-CMP waste water, which had been subjected to the hydrogen peroxide decomposition treatment, prepared in Example 10 was adjusted to a pH of 3 by the addition of sulfuric acid and EMULGEN 1118 S-70 manufactured by Kao Corporation as a nonionic surfactant. Additive rate of the nonionic surfactant was 300 mg/l. In this state, the ζ potential of the slurry was measured and found to be in the range of 0 to −10 mV.

The Cu-CMP waste water after the addition of the surfactant was used as raw water and was subjected to a treatment test with a Cu treatment apparatus shown in FIG. 6. The treatment was carried out under the same conditions as those in Example 10. The treatment operation was continued for 5 days. Then, the operating voltage was stable at a voltage of 23 V, and the concentration of Cu in the treated water was less than 0.1 mg-Cu/l during the treatment operation. The quality of the treated water was lower than that in Example 10. After the operation of the apparatus, the electrodialysis apparatus in the separation step was dismantled, and the interiors of the first desalting chamber and the second desalting chamber were inspected. As a result, it was confirmed that there was no coagulation of the slurry at all. Thus, it was confirmed that the utilization of the nonionic surfactant further enhanced Cu treatment performance.

### Example 14

The Cu-CMP waste water, which had been subjected to the hydrogen peroxide decomposition treatment, prepared in Example 10 was adjusted to a pH of 3 by the addition of sulfuric acid and NEOPELEX GS manufactured by Kao Corporation as H-type anionic surfactant having sulfo group. Additive rate of the H-type anionic surfactant was 300 mg/l.

The Cu-CMP waste water to which the surfactant had been added was prepared as raw water and was supplied to an ion exchange resin column packed with strongly acidic cation-exchange resin beads. The water flowing speed was LV 30 m/hour. As a result, the concentration of Cu in the treated water was less than 0.5 mg/l even after water flowing for 24 hours.

### Example 15

The Cu-CMP waste water, which had been subjected to the hydrogen peroxide decomposition treatment, prepared in Example 10 was adjusted by the addition of anionic surfactant having sulfo group (POLITY PS-1900, manufactured by Lion Corporation). Additive rate of the anionic surfactant was 300 mg/l.

The Cu-CMP waste water to which the surfactant had been added was prepared as raw water and was supplied to an ion exchange resin column packed with cation-exchange resin beads having iminodiacetic acid group. The water flowing speed was LV 30 m/hour. As a result, the concentration of Cu in the treated water was less than 0.5 mg/l even after water flowing for 24 hours.

### Example 16

NEOPELEX GS manufactured by Kao Corporation as H-type anionic surfactant having sulfo group was added to the Cu-CMP waste water, which had been subjected to the hydrogen peroxide decomposition treatment, prepared in Example 10. Additive rate of the H-type anionic surfactant was 300 mg/l.

The Cu-CMP waste water to which the surfactant had been added was prepared as raw water and was supplied to an ion exchange resin column packed with cation-exchange resin beads having iminodiacetic acid group. The water flowing speed was LV 30 m/hour. As a result, the concentration of Cu in the treated water was less than 0.5 mg/l even after water flowing for 24 hours.

### Example 17

In a Cu-CMP apparatus as shown in FIG. 28A comprising a Cu polishing unit and a barrier-layer polishing unit which have respective turntables, waste water discharged only from the Cu polishing unit was collected and used as raw water. In the waste water in a slurry particle-suspended form, the TS (total solid) value was 5000 mg/l, the Cu concentration was 150 mg/l, and the H₂O₂ concentration was 1400 mg/l, the main component of the slurry was silica, and the ζ potential of the slurry was −20 mV. The hydrogen peroxide was decomposed using the same hydrogen peroxide decomposition apparatus as that in Example 10.

The catalyst used was a platinum-coated metal honeycomb catalyst (having an acid-resistant coating), and had a pore density of 500 cell/square inch. The amount of platinum coated by the metal honeycomb catalyst was 5 g/l. The treatment was carried out under conditions of water flowing speed 30 m/hour and contact time 3 minutes (in total of three columns). As a result, the concentration of hydrogen peroxide in the raw water was reduced to less than 5 mg/l by the decomposition.

The waste water, which had been subjected to the hydrogen peroxide decomposition treatment, was adjusted to a pH of 3 by the addition of sulfuric acid and NEOPELEX GS manufactured by Kao Corporation as H-type anionic surfactant having sulfo group. Additive rate of the H-type anionic surfactant was 300 mg/l. In this state, the ζ potential of the slurry was measured and found to be −30 mV. This value was lower than a ζ potential −15 mV in a case where only sulfuric acid was used for the pH adjustment.

The Cu-CMP waste water after the addition of the surfactant was used as raw water and was subjected to a treatment test with a Cu treatment apparatus shown in FIG. 6. The treatment was carried out under the same conditions as those in Example 10. The treatment operation was continued for 5 days. Then, the operating voltage was stable at a voltage of 20 V, and the concentration of Cu in the treated water was less than 0.5 mg-Cu/l. After the operation of the apparatus, the electrodialysis apparatus in the separation step was dismantled, and the interiors of the first desalting chamber and the second desalting chamber were inspected. As a result, it was confirmed that there was no coagulation of the slurry at all. Thus, it was confirmed that good results could be obtained even when the waste water to be treated was only waste water discharged from the Cu polishing step carried out by the Cu-CMP apparatus.

### Example 18

In a Cu-CMP apparatus as shown in FIG. 28B for performing a Cu polishing step and a barrier-layer polishing step by the same turntable, waste water discharged only from the Cu polishing step was collected and used as raw water. In the waste water in a slurry particle-suspended form, the TS (total solid) value was 3000 mg/l, the Cu concentration was 150 mg/l, and the H₂O₂ concentration was 2000 mg/l, the main component of the slurry was silica, and the ζ potential of the slurry was −20 mV. The hydrogen peroxide was decomposed using the same hydrogen peroxide decomposition apparatus as that in Example 10.

The catalyst used was a platinum-coated metal honeycomb catalyst (having an acid-resistant coating), and had a pore density of 500 cell/square inch. The amount of platinum coated by the metal honeycomb catalyst was 5 g/l. The treatment was carried out under conditions of water flowing speed 30 m/hour and contact time 3 minutes (in total of three columns). As a result, the concentration of hydrogen peroxide in the raw water was reduced to less than 5 mg/l by the decomposition.

The waste water, which had been subjected to the hydrogen peroxide decomposition treatment, was adjusted to a pH of 3 by the addition of sulfuric acid and NEOPELEX GS manufactured by Kao Corporation as H-type anionic surfactant having sulfo group. Additive rate of the H-type anionic surfactant was 300 mg/l. In this state, the ζ potential of the slurry was measured and found to be −35 mV. This value was lower than a ζ potential −15 mV in a case where only sulfuric acid was used for the pH adjustment.

The Cu-CMP waste water after the addition of the surfactant was used as raw water and was subjected to a treatment test with a Cu treatment apparatus shown in FIG. 6. The treatment was carried out under the same conditions as those in Example 10. The treatment operation was continued for 5 days. Then, the operating voltage was stable at a voltage of 20 V, and the concentration of Cu in the treated water was less than 0.5 mg-Cu/l. After the operation of the apparatus, the electrodialysis apparatus in the separation step was dismantled, and the interiors of the first desalting chamber and the second desalting chamber were inspected. As a result, it was confirmed that there was no coagulation of the slurry at all. Thus, it was confirmed that good results could be obtained even when the waste water to be treated was only waste water discharged from the Cu polishing step carried out by the Cu-CMP apparatus.

As described above, according to the present invention, water to be treated, containing copper, can be treated so as to provide treated water having a lowered copper concentration, and the copper can be recovered in the form of metal element. For example, waste water discharged from a semiconductor fabrication process (e.g., a CMP process or a copper plating process) can be treated so as to provide treated water having a copper concentration lower than a discharge limit, and copper can be recovered as copper metal from the waste water. Therefore, the present invention is extremely effective in view of discharge limit and resource saving.

Although certain preferred embodiments of the present invention have been shown and described in detail, it should be understood that various changes and modifications may be made therein without departing from the scope of the appended claims.

### INDUSTRIAL APPLICABILITY

The present invention is suitable for use in a method and apparatus for removing and recovering metal such as copper from various kinds of waste water discharged from a CMP step, a copper plating step, or the like.

1. A method for treating waste water containing copper, comprising:
treating waste water in a copper treatment step comprising a combination of electrodialysis operation and electrolytic deposition operation to produce treated water having a lowered copper concentration; and
recovering copper from the waste water.

2. A method for treating waste water containing copper, comprising:
decomposing oxidizing agent in waste water in an oxidizing agent decomposition step;
supplying the waste water discharged from said oxidizing agent decomposition step to a copper treatment step;
treating the waste water in said copper treatment step comprising a combination of electrodialysis operation and electrolytic deposition operation to produce treated water having a lowered copper concentration; and
recovering copper from the waste water.

3. A method for treating waste water according to claim 2, wherein said oxidizing agent decomposition step uses a platinum-coated catalyst.

4. A method for treating waste water according to claim 2, wherein said oxidizing agent decomposition step comprises a hydrogen peroxide decomposition step.

5. A method for treating waste water according to claim 1, wherein said copper recovered from the waste water comprises copper metal.

6. A method for treating waste water according to claim 3, further comprising a slurry separation step for separating slurry from the waste water, said slurry separation step being provided between said oxidizing agent decomposition step and said copper treatment step.

7. A method for treating waste water according to claim 6, wherein said slurry separation step includes coagulating separation treatment or filtering treatment.

8. A method for treating waste water according to claim 1, wherein said copper treatment step comprises a separation step for separating and concentrating copper in the waste water by electrodialysis operation as CuSO₄ concentrated water, a recovering step for depositing copper on a cathode of an electrolytic deposition apparatus by electrolytic deposition operation of the CuSO₄ concentrated water, and an acid recovery step for recovering sulfuric acid from treated water of said recovery step.

9. A method for treating waste water according to claim 1, further comprising a ζ potential converting step provided at a preceding stage of said copper treatment step;
wherein the waste water containing solid fine particles is treated by said ζ potential converting step.

10. A method for treating waste water according to claim 1, wherein the waste water containing solid fine particles is directly introduced into said copper treatment step when a ζ potential of said fine particles is a negative value.

11. A method for treating waste water according to claim 9, wherein in said ζ potential converting step, organic compound having sulfo group is added to the waste water.

12. A method for treating waste water according to claim 9, wherein said solid fine particles comprise abrasive particles used in a CMP step.

13. A method for treating waste water according to claim 12, wherein said abrasive particles contain at least one of SiO₂, Al₂O₃ and CeO₂.

14. A method for treating waste water according to claim 9, wherein in said ζ potential converting step, a surfactant or a pH adjusting agent is added to the waste water.

15. A method for treating waste water containing copper, comprising:
treating waste water in a copper treatment step comprising a combination of electrodialysis operation and electrolytic deposition operation to produce treated water having a lowered copper concentration, the waste water comprising waste water discharged from a CMP step for polishing a semiconductor substrate having a copper layer thereon and/or a cleaning step for cleaning the polished semiconductor substrate using a cleaning liquid; and
recovering copper from the waste water.

16. A method for treating waste water according to claim 15, wherein said copper recovered from the waste water comprises copper metal.

17. A method for treating waste water according to claim 15, further comprising a ζ potential converting step provided at a preceding stage of said copper treatment step.

18. A method for treating waste water according to claim 15, further comprising a ζ potential converting step at a preceding stage of said copper treatment step;
wherein the waste water containing solid fine particles is treated by said ζ potential converting step.

19. A method for treating waste water according to claim 17, wherein in said ζ potential converting step, a surfactant or a pH adjusting agent is added to the waste water.

20. A method for treating waste water according to claim 14, wherein said surfactant comprises an anionic surfactant or a nonionic surfactant.

21. A method for treating waste water according to claim 20, wherein said anionic surfactant contains no metal cation.

22. A method for treating waste water according to claim 18, wherein said solid fine particles comprise abrasive particles, and said abrasive particles contain at least one of SiO₂, Al₂O₃ and CeO₂.

23. A method for treating waste water according to claim 15, wherein said cleaning liquid in said cleaning step contains a surfactant.

24. A method for treating waste water containing copper, comprising:
introducing waste water into a ζ potential converting step to convert a ζ potential of solid fine particles in the waste water into a negative value, the waste water comprising waste water discharged from a CMP step for polishing a semiconductor substrate having a copper layer thereon and/or a cleaning step for cleaning the polished semiconductor substrate using a cleaning liquid; and
treating the waste water containing said fine particles in an ion-exchange treatment step to produce treated water having a lowered copper concentration.

25. A method for treating waste water according to claim 24, further comprising an oxidizing agent decomposition step provided at a preceding stage of said ion-exchange treatment step.

26. A method for treating waste water containing copper, comprising:
introducing waste water into a ζ potential converting step to convert a ζ potential of solid fine particles in the waste water into a negative value, the waste water comprising waste water discharged from a CMP step for polishing a semiconductor substrate having a copper layer thereon and/or a cleaning step for cleaning the polished semiconductor substrate using a cleaning liquid; and
treating the waste water containing said fine particles in a coagulating sedimentation treatment step or a coagulating separation treatment step to produce treated water having a lowered copper concentration.

27. A method for treating waste water according to claim 26, further comprising an oxidizing agent decomposition step provided at a preceding stage of said coagulating sedimentation treatment step or said coagulating separation treatment step.

28. A method for treating waste water, comprising:
treating waste water discharged only from a copper polishing step in a CMP step to produce treated water having a lowered copper concentration.

29. A method for treating waste water according to claim 28, wherein said treating waste water comprises at least one of electrodialysis treatment, electrolytic deposition treatment, ion-exchange treatment, and coagulating sedimentation treatment.

30. An apparatus for treating waste water containing copper, comprising:
an electrodialysis apparatus; and
an electrolytic deposition apparatus;
wherein waste water is treated by a combination of said electrodialysis apparatus and said electrolytic deposition apparatus to produce treated water having a lowered copper concentration and to recover copper.

31. An apparatus for treating waste water according to claim 30, wherein said copper recovered from the waste water comprises copper metal.

32. An apparatus for treating waste water according to claim 30, wherein said electrodialysis apparatus performs electrodialysis operation of the waste water to separate and concentrate copper in the waste water as CuSO₄ concentrated water;
said electrolytic deposition apparatus performs electrolytic deposition operation of the CuSO₄ concentrated water to deposit copper on a cathode of said electrolytic deposition apparatus;
further comprising:
an acid recovery apparatus for recovering sulfuric acid from treated water discharged from said electrolytic deposition apparatus.

33. An apparatus for treating waste water according to claim 32, wherein said electrodialysis apparatus has a desalting chamber packed with an ion-exchanger.

34. An apparatus for treating waste water according to claim 33, further comprising a ζ potential converting apparatus provided at a preceding stage of said electrodialysis apparatus.

35. An apparatus for treating waste water according to claim 34, wherein said ζ potential converting apparatus comprises a chemical storage tank configured to store a surfactant or a pH adjusting agent, and an adding device configured to add said surfactant or said pH adjusting agent stored in said chemical storage tank to the waste water.

36. An apparatus for treating waste water according to claim 35, wherein said surfactant comprises an anionic surfactant or a nonionic surfactant.

37. An apparatus for treating waste water according to claim 36, wherein said anionic surfactant contains no metal cation.

38. A method for treating waste water according to claim 2, wherein said copper recovered from the waste water comprises copper metal.

39. A method for treating waste water according to claim 2, wherein said copper treatment step comprises a separation step for separating and concentrating copper in the waste water by electrodialysis operation as CuSO₄ concentrated water, a recovering step for depositing copper on a cathode of an electrolytic deposition apparatus by electrolytic deposition operation of the CuSO₄ concentrated water, and an acid recovery step for recovering sulfuric acid from treated water of said recovery step.

40. A method for treating waste water according to claim 2, further comprising a ζ potential converting step provided at a preceding stage of said copper treatment step;
wherein the waste water containing solid fine particles is treated by said ζ potential converting step.

41. A method for treating waste water according to claim 2, wherein the waste water containing solid fine particles is directly introduced into said copper treatment step when a ζ potential of said fine particles is a negative value.

42. A method for treating waste water according to claim 40, wherein in said ζ potential converting step, organic compound having sulfo group is added to the waste water.

43. A method for treating waste water according to claim 40, wherein said solid fine particles comprise abrasive particles used in a CMP step.

44. A method for treating waste water according to claim 43, wherein said abrasive particles contain at least one of SiO₂, Al₂O₃ and CeO₂.

45. A method for treating waste water according to claim 40, wherein in said ζ potential converting step, a surfactant or a pH adjusting agent is added to the waste water.

46. A method for treating waste water according to claim 45, wherein said surfactant comprises an anionic surfactant or a nonionic surfactant.

47. A method for treating waste water according to claim 19, wherein said surfactant comprises an anionic surfactant or a nonionic surfactant.

48. A method for treating waste water according to claim 46, wherein said anionic surfactant contains no metal cation.

49. A method for treating waste water according to claim 47, wherein said anionic surfactant contains no metal cation.

50. A method for treating waste water according to claim 20, wherein said cleaning liquid in said cleaning step contains a surfactant.

51. A method for treating waste water according to claim 46, wherein said cleaning liquid in said cleaning step contains a surfactant.
